(19) United States
(12) Patent Application Publication
(10) Pub. No.: US 2014/0244292 A1
(43) Pub. Date: Aug. 28, 2014

(54) Method for Helping Patients Find Treatments Based on Similar Patients' Experiences

(71) Applicant: WISER TOGETHER, INC., Washington, DC (US)

(72) Inventors: Gregg Rosenberg, Washington, DC (US); Erik Labianca, Washington, DC (US); Shubadeep Debgupta, Washington, DC (US); Ian Soper, Washington, DC (US); Heather Zirkle, Washington, DC (US)

(73) Assignee: WISER TOGETHER, INC., Washington, DC (US)

(21) Appl. No.: 14/272,014

(22) Filed: May 7, 2014

Related U.S. Application Data
(63) Continuation-in-part of application No. 13/015,176, filed on Jan. 27, 2011.
(60) Provisional application No. 61/820,618, filed on May 7, 2013.

(51) Int. Cl. G06F 19/00

(52) U.S. Cl. CPC G06F 19/3487
USPC 705/2

(57) ABSTRACT

This disclosure describes, among other things, a method for recommending treatments for a condition (e.g., a medical condition). The method may include generating ranking treatments for a condition based on patient information. The patient information may identify one or more characteristics of a patient. The patient information may include clinical and/or non-clinical information. The treatments may be ranked based on a prediction of the degree to which the patient will be satisfied with the treatment. The prediction may be based on the degree to which other patients were satisfied with the treatment.

### CROSS-REFERENCE TO RELATED APPLICATIONS

The present application claims the benefit of priority to U.S. Provisional Application No. 61/820,618, which was filed on May 7, 2013, and is incorporated by reference herein in its entirety. In addition, the present application is a continuation-in-part of U.S. patent application Ser. No. 13/015,176, filed on Jan. 27, 2011, which is incorporated by reference herein in its entirety.

### BACKGROUND

1. Field of Invention

The present invention relates generally to the recommendation of treatments for a condition. Specifically, the present invention may relate to the generation of treatment rankings based on patient information identifying one or more characteristics of a patient.

2. Discussion of Background

A great many health conditions have a large variety of potential treatments. For example, for high blood pressure, there are at least twenty broad types of treatment in categories as diverse as prescription medications, preventive care, and lifestyle change. However, given the limited time patients have with doctors and the limited knowledge patients have about the differences between treatments, the large number of potential treatments often presents an obstacle to productive patient involvement in treatment choice. This is a problem because studies show that patients who are more involved in choosing their care tend to get better outcomes. Accordingly, there is a need in the art for improved methods and systems for helping patients find treatments.

### SUMMARY

The present invention provides, among other advantages, improved methods and systems for helping patients find treatments. For best patient outcomes (from the patient perspective), patients desire to (i) have awareness of options their doctors might not tell them about, (ii) be able to narrow down their treatment options to the few treatments most likely worth talking deeply about, and (iii) to deliberatively weigh the cost/benefit of their treatment choices. For best patient outcomes (from the doctor perspective), doctors want to get buy-in and adherence from patients by explaining treatment recommendations knowing the value, lifestyle, and financial preferences that are likely to influence a patient's understanding and behavior towards their treatment.

Patients and doctors face several obstacles in getting to a state most likely to produce the best patient outcomes. First, because of the cost of large scale clinical studies, there is a substantial majority of treatment alternatives in use for which there is insufficient clinical evidence regarding how effective it is and under what circumstances. It is hard for patients or doctors to find or use informal or indicative evidence about patient experiences with these treatments. Second, patients with the same condition who use the same treatment will often experience different outcomes. This outcome variation is only partially explained by clinical information about the patient or the treatment. Much of the outcome variation has to do with nonclinical information about the patient's lifestyle, values, preferences, work conditions, financial conditions, etc. Patients need a meaningful way to correlate this nonclinical information with treatment choice to make shared decisions. Third, in the United States, the time doctors spend with patients to understand their individual situations is getting shorter and shorter, as both caseloads and administrative loads increase faster than the physician population. As a result, doctors may avoid shared decision making and patient-centered care because it takes more time to understand what is personal about a patient's feelings and situation and how to apply that to treatment choice.

Some aspects of the invention may alleviate one or more of the obstacles set forth above by providing methods and systems to help patients create a short list of one or more treatments for deeper investigation. In some embodiments, the methods and systems may help doctors understand what patient characteristics are most likely to affect treatment success. In some embodiments, the methods and systems may use a database relating patient clinical and nonclinical information to patient outcome experiences. In some embodiments, the patient clinical information may include one or more of medical history, comorbidities, allergies, severity of condition, and similar information collected in a clinical setting. In some embodiments, patient nonclinical information may include one or more of extended demographic information, career or job information, financial information, information about patient values, preferences and behaviors, and other such information that can impact a patient's understanding of and adherence to a treatment plan.

In some embodiments, the methods and systems may combine both physiological data, which may come from electronic records, with broad-based patient sourced data about preferences and non-physiological situational factors affecting treatment outcomes. As a result, the methods and systems may be capable of ranking treatments according to likely patient preference and adherence within the confines of medical guidelines. In some embodiments, the methods and systems may create a real-time back and forth, with “what if” capability, between the user and the rankings to enable user exploration and education (e.g., via the provision of detailed content to the user). In some embodiments, the methods and systems may be configured to educate patients and help patients engage in the treatment selection process.

One aspect of the invention may provide a method of recommending treatments. The method may include receiving, at a computer, an identification of a condition from a device remote from the computer. The method may include receiving an identification of treatments for the identified condition from a storage device. The method may include receiving treatment information about the identified treatments from the storage device. The received treatment information may include one or more of an indication of the clinical effectiveness of the identified treatments, data characterizing experiences of patients with the identified treatments, cost information, and insurance coverage. The method may include generating initial rankings of the identified treatments based on the treatment information. The method may include transmitting the initial rankings to the remote device. The method may include receiving patient information identifying one or more characteristics of a patient from the remote device. The method may include generating updated rankings of the identified treatments based on the treatment information and the received patient information. The method may include transmitting the updated rankings to the remote device.

In some embodiments, generating the updated rankings may include receiving similar-patient information about the identified treatments from the storage device and ranking the identified treatments based on the treatment information and the received similar-patient information. The similar-patient information may include treatment information specific to patients sharing one or more of the characteristics of the patient identified by the patient information. The similar-patient information may include one or more of an indication of the clinical effectiveness of the identified treatments for patients sharing one or more of the characteristics of the patient identified by the patient information and data characterizing the experiences of patients sharing one or more of the characteristics of the patient identified by the patient information with the identified treatments.

In some embodiments, the patient information includes clinical information. The clinical information may include one or more of condition status information, demographic information, a previous condition of the patient, a current condition of the patient, and allergies of the patient. The condition status information may include an identification of one or more of the severity of the identified condition in the patient and the length of time that the patient has had the identified condition. The demographic information may include an identification of one or more of the gender of the patient, the race or ethnicity of the patient, the age of the patient, the height of the patient, the weight of the patient, the household income of the patient, the level of education achieved by the patient, the extent to which the patient's job is physically demanding, and whether the patient is a medical professional.

In some embodiments, the patient information includes non-clinical information. The non-clinical information may include one or more of treatment preference information, treatment value information, willingness information, and information about one or more behaviors of the patient. The treatment preference information may include an identification of one or more treatments that the patient is currently using or leaning towards using for the identified condition. The treatment value information may include an identification of the extent to which the patient values one or more of treatment effectiveness, how quickly a treatment works, treatment cost, treatment popularity of the treatment, and the side effects of a treatment when choosing a treatment. The willingness information may include an identification of one or more of the extent to which the patient is willing to take prescription medications, the extent to which the patient is willing to use alternative medicine therapies, and the extent to which the patient is willing to undergo surgery or other invasive treatments.

In some embodiments, the method may include receiving a selection of a treatment from the remote device and transmitting detail information about the selected treatment to the remote device. The detail information may include one or more of a description of the selected treatment, the popularity of the selected treatment with patients that have used the selected treatment, the effectiveness of the selected treatment with patients that have used the selected treatment, clinical evidence of effectiveness of the selected treatment, potential side effects of the selected treatment, potential impacts on work of the selected treatment, speed of effectiveness of the selected treatment, out-of-pocket costs of the selected treatment, total costs of the selected treatment, and potential pain of the selected treatment.

In some embodiments, the method may include comparing the initial rankings and the updated rankings to generate difference information and transmitting the difference information to the remote device. In some embodiments, generating the updated rankings may include determining the impact of each of the one or more characteristics of the patient identified in the patient information on the updated rankings relative to the initial rankings, and transmitting the updated rankings may include transmitting the determined relative impact of each of the one or more characteristics of the patient. In some embodiments, generating the updated rankings may include ranking the identified treatments from the identified treatment most likely to be a good match for the patient to the identified treatment least likely to be a good match for the patient based on the received patient information.

In some embodiments, the storage device may have a database stored therein, and the database may contain information about patients, conditions that the patients had or have, treatments used on the conditions that the patients had or have, outcomes of the treatments used on the conditions that the patients have or had, and one or more of clinical information about the patients and non-clinical information about the patients. Generating the updated rankings may include determining one or more similar patients who have had one or more of the identified treatments on the identified condition; receiving, from the storage device, similar patient outcome information for the one or more of the identified treatments used on the identified condition for the similar patients; and ranking the identified treatments based on the treatment information and the received similar patient outcome information. The similar patient outcome information may include one or more outcomes of one or more treatments of the identified treatments on the identified condition of the similar patients, and the generating the updated rankings may include, for each outcome, weighting the outcome based upon the degree to which the one or more characteristics of the patient identified by the received patient information matches one or more characteristics of the similar patient of the similar patients having the outcome. Generating the updated rankings may include using a predictive matching algorithm to analyze the received patient information against the information contained in the database and to generate predictions of the likelihood that the patient will consider the outcome of each of the identified treatments successful. Generating the updated rankings may include generating, for each of the similar patients, a confidence level that the similar patient is representative of the patient based upon the degree to which the one or more characteristics of the patient identified by the received patient information matches one or more characteristics of the similar patient.

In some embodiments, the method may include creating a profile for the patient including the received patient information, and transmitting the profile to the storage device. The method may include receiving additional patient information identifying one or more additional characteristics of the patient; generating further updated rankings of the identified treatments based on the treatment information, the received patient information, and the received additional patient information; and transmitting the further updated rankings to the remote device.

In some embodiments, the method may include receiving an identification of one of a profile or sub-profile for the patient from the remote device, and the identified one of the profile or sub-profile for the patient may be stored in the storage device and may include stored patient information identifying one or more characteristics of the patient. The method may include receiving the stored patient information from the storage device. Generating the initial rankings may be based on the treatment information and the stored patient information. Generating the updated rankings may be based on the treatment information, the received patient information, and the stored patient information. Another aspect of the invention may provide a computer system for recommending treatments. The computer system may include a storage device, a computer, and a computer readable medium storing computer readable instructions executable by the computer. The computer may be operative to receive an identification of a condition from a remote device. The computer may be operative to receive an identification of treatments for the identified condition from the storage device. The computer may be operative to receive treatment information about the identified treatments from the storage device, wherein the received treatment information includes one or more of an indication of the clinical effectiveness of the identified treatments, data characterizing patients' experiences with the identified treatments, cost information, and insurance coverage. The computer may be operative to generate initial rankings of the identified treatments based on the treatment information. The computer may be operative to transmit the initial rankings to the remote device. The computer may be operative to receive patient information identifying one or more characteristics of a patient from the remote device. The computer may be operative to generate updated rankings of the identified treatments based on the treatment information and the received patient information. The computer may be operative to transmit the updated rankings to the remote device.

Still another aspect of the invention may provide a computer program product for recommending treatments. The computer program product may include a non-transitory computer readable medium storing computer readable instructions. The instructions may include instructions for receiving an identification of a condition from a remote device. The instructions may include instructions for receiving an identification of treatments for the identified condition from the storage device. The instructions may include instructions for receiving treatment information about the identified treatments from the storage device, wherein the received treatment information includes one or more of an indication of the clinical effectiveness of the identified treatments, data characterizing patients' experiences with the identified treatments, cost information, and insurance coverage. The instructions may include instructions for generating initial rankings of the identified treatments based on the treatment information. The instructions may include instructions for transmitting the initial rankings to the remote device. The instructions may include instructions for receiving patient information identifying one or more characteristics of a patient from the remote device. The instructions may include instructions for generating updated rankings of the identified treatments based on the treatment information and the received patient information. The instructions may include instructions for transmitting the updated rankings to the remote device.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 is a schematic view illustrating a system embodying aspects of the present invention.

FIG. 2 is a schematic view illustrating a treatment recommendation computer system embodying aspects of the present invention.

FIG. 3 is a flow chart illustrating a treatment recommendation process according to some embodiments.

FIG. 4 is a flow chart illustrating a treatment ranking updating process according to some embodiments.

FIG. 5 is a block diagram of a treatment recommendation computer system according to some embodiments.

FIG. 6 is a flow chart illustrating a treatment recommendation process according to some embodiments.

FIG. 7 is a block diagram of a remote device according to some embodiments.

FIGS. 8A-8C illustrate displays of conditions according to some embodiments.

FIGS. 9A and 9B illustrate displays of initial treatment rankings according to some embodiments.

FIGS. 10A-10H illustrate patient information displays according to some embodiments.

FIGS. 11A-11C illustrate displays of initial treatment rankings, updated treatment rankings, and twice updated treatment rankings, respectively, according to some embodiments.

FIG. 12 illustrates a display of treatment detail information according to some embodiments.

FIG. 13 illustrates a patient relationship display according to some embodiments.

FIG. 14 illustrates a plan or attitude adjustment display according to some embodiments.

### DETAILED DESCRIPTION

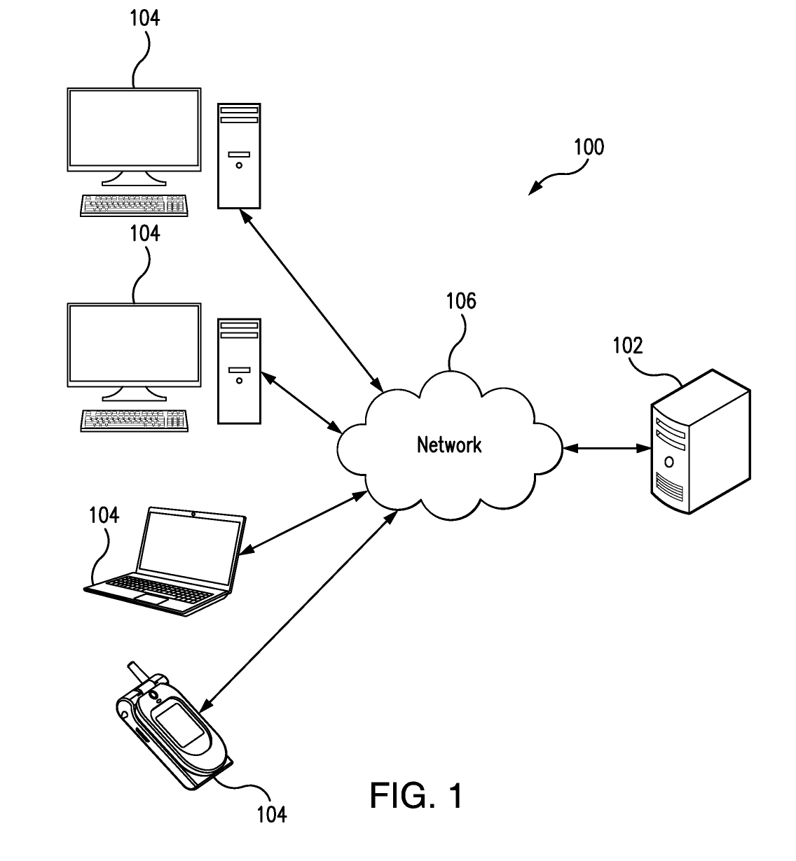

FIG. 1 is a schematic view of a system 100 embodying aspects of the present invention. In some embodiments, the system 100 may include a treatment recommendation computer system 102. In some non-limiting embodiments, the treatment recommendation computer system 102 may be a server. In some embodiments, the treatment recommendation computer system 102 may be connected to a network 106. In some non-limiting embodiments, the network 106 may include, for example, one or more of the Internet, a Wide Area Network (WAN), a local area network (LAN), and a wireless (e.g., cellular) network. In some embodiments, the treatment recommendation computer system 102 may transmit and receive information to and from the network 106.

In some embodiments, the system 100 may include one or remote devices 104 (e.g., client devices). In some non-limiting embodiments, a remote device 104 may be, for example, a desktop computer, a laptop computer, a tablet computer, or a smartphone. In some non-limiting embodiments, a remote device 104 may include a user interface (e.g., a display and/or input device, such as, for example, a mouse, touchpad, keyboard, stylus, microphone, or touchscreen). In some embodiments, a remote device 104 may transmit and receive information to and from the network 106. In some embodiments, a remote device 104 may connect with the treatment recommendation computer system 102 (e.g., via a web browser executed on the remote device 104), and the remote device 102 may transmit and receive information to and from the treatment recommendation computer system 102 over the network 106.

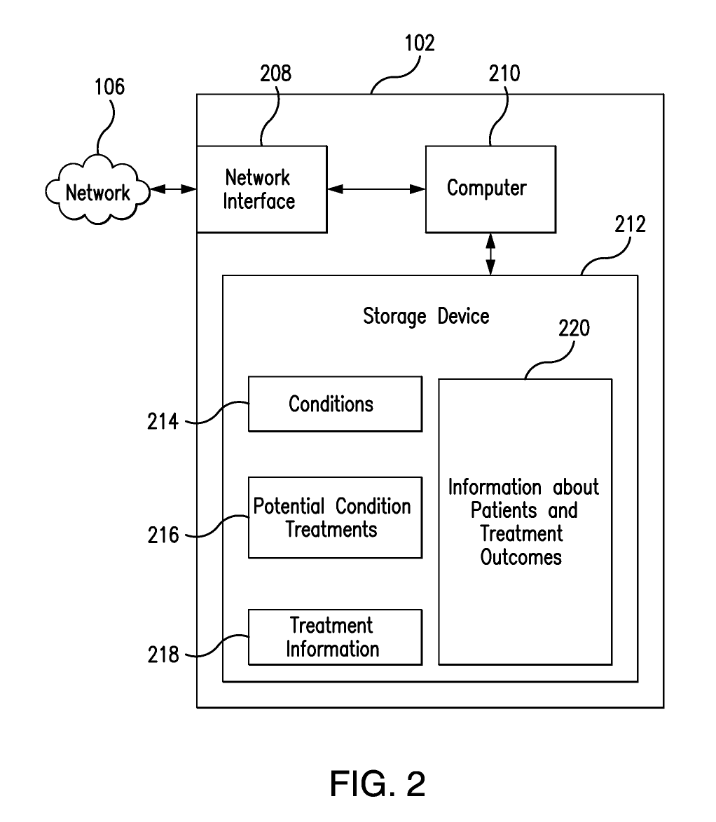

FIG. 2 is a schematic view of a non-limiting embodiment of the treatment recommendation computer system 102, which may be included in the system 100 illustrated in FIG. 1. As illustrated in FIG. 2, in some embodiments, the treatment recommendation computer system 102 may include a network interface 208, a computer 210, and a storage device 212. The network interface 208 may be connected to the network 106. The network interface 208 may facilitate transmission of data from the computer 210 over the network 106 and receipt of information from the network 106 to the computer 210.

In some embodiments, the storage device 212 may be a non-volatile storage device. In some embodiments, the storage device 212 may store one or more of conditions 214, potential condition treatments 216, treatment information 218, and information about patients and treatment outcomes 220. In some non-limiting embodiments, the conditions 214 may include one or more health conditions, such as, for example, acne, acute respiratory distress syndrome, allergies, anemia, aortic aneurysm, brain aneurysm, lower limb aneurysm, thoracic aortic aneurism, anorexia, anxiety disorder, aortic valve disease, asthma, attention deficit hyperactive disorder, autism, back pain, behavioral addiction, bipolar disorder, etc.

In some non-limiting embodiments, the potential condition treatments 216 may include one or more treatments for the conditions 214. For instance, in one non-limiting embodiment, the conditions 214 may include high blood pressure, and the potential condition treatments 216 may include categories of high blood pressure treatments, such as, for example and without limitation, stress reduction, wait and see, diet improvement, exercise, weight loss, alcohol limitation, caffeine limitation, quitting smoking, beta blockers, diuretics, calcium channel blockers, renin inhibitors, alpha blockers, vasodilators, alpha-beta blockers, angiotensin II receptor blockers, angiotensin-converting enzyme inhibitors, and nervous system inhibitors. In one non-limiting embodiment, the potential condition treatments 216 may include one or more specific products from treatment manufacturers under their generic names, such as, for example and without limitation, benazepril, captopril, enalapril, fosinopril, and Lisinopril, and/or under a brand name, such as, for example and without limitation, Lotensin, Capoten, Vasotec, Monopril, and Prinivil.

In some non-limiting embodiments, the treatment information 218 includes one or more of an indication of the clinical effectiveness of the potential condition treatments 216, data characterizing experiences of patients with the potential condition treatments 216, information about the cost of the potential condition treatments 216, and information about insurance coverage for the potential condition treatments 216. In some non-limiting embodiments, the information about patients and treatment outcomes 220 may include one or more of information about patients, conditions that the patients had or have, treatments used on the conditions that the patients had or have, outcomes of the treatments used on the conditions that the patients have or had, clinical information about the patients, and non-clinical information about the patients. In some non-limiting embodiments, the outcome information may include one or more of patients' ratings of how successful treatments were at treating conditions, doctors' ratings of how successful treatments were at treating conditions, how quickly the treatments worked, the side effects of the treatment, the difficulty patients experienced with the treatment, the ability of the patient to adhere to the treatment, the location of administration of the treatment, the likelihood that patients would recommend the treatment to another patient, patients' rating of overall effectiveness, the amount of time they missed work undergoing the treatment, whether patients experienced a recurrence of the condition, the degree of satisfaction they experienced while undergoing the treatment regimen, the amount of discomfort they experienced in the course of the treatment regimen, the total out of pocket cost of the treatment regimen, and various clinical condition-specific outcome measurements. In some embodiments, the information about patients and treatment outcomes 220 may have been compiled from patient and/or doctor surveys (e.g., thousands of patient surveys and thousands of doctor surveys). In some embodiments, the information about patients and treatments outcomes 220 may be compiled from personal health records, medical claims, and/or electronic medical records. In some embodiments, information from patient and/or doctor surveys may be combined with information from personal health records, claims, and medical records to form the information about patients and treatments outcomes 220.

In some embodiments, the computer 210 may receive information from a remote device 104 (e.g., via network 106 and network interface 208). In some non-limiting embodiments, based on the received information, the computer 210 may access information stored in the storage device 212, generate rankings of treatments for a medical condition, and transmit the generated treatment rankings to the remote device (e.g., via network interface 208 and network 106).

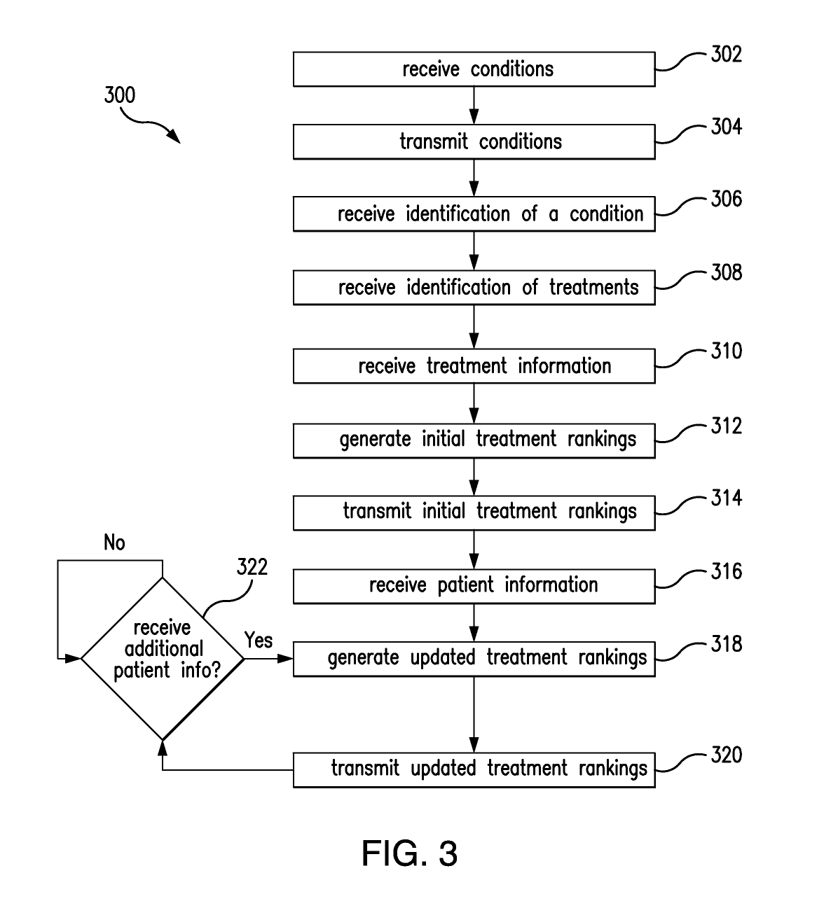

FIG. 3 is a flow chart illustrating a process 300 for recommending treatments according to some embodiments. In some embodiments, the process 300 may begin in step 302 with the computer 210 receiving conditions 214 from the storage device 212. In some non-limiting embodiments, step 302 may include requesting and receiving the conditions 214 from the storage device 212.

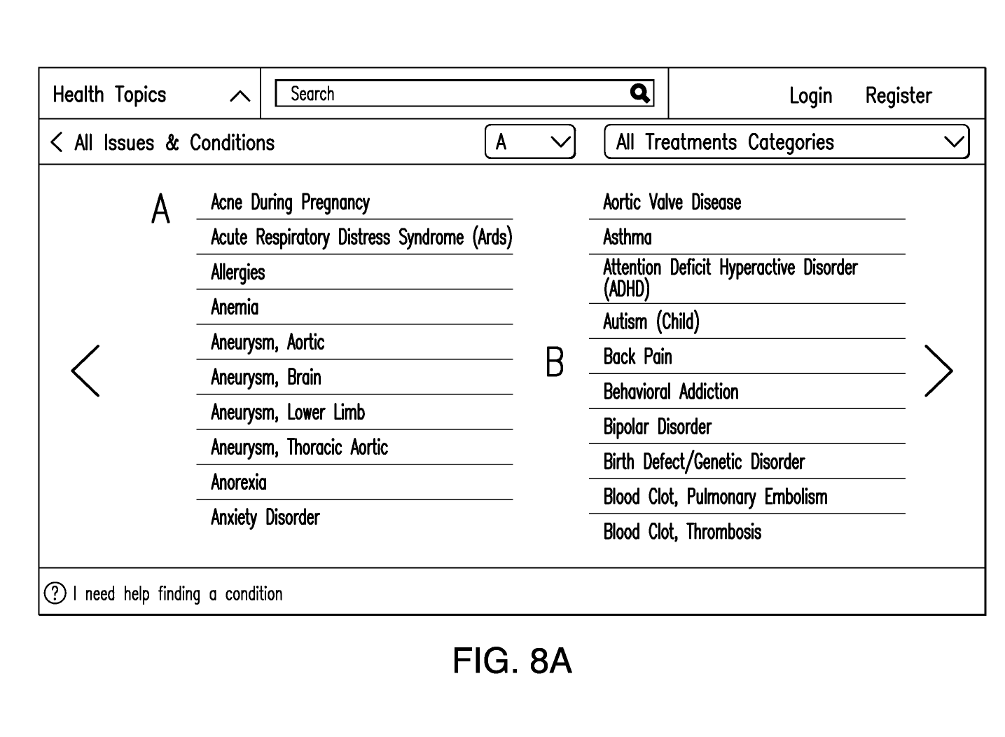

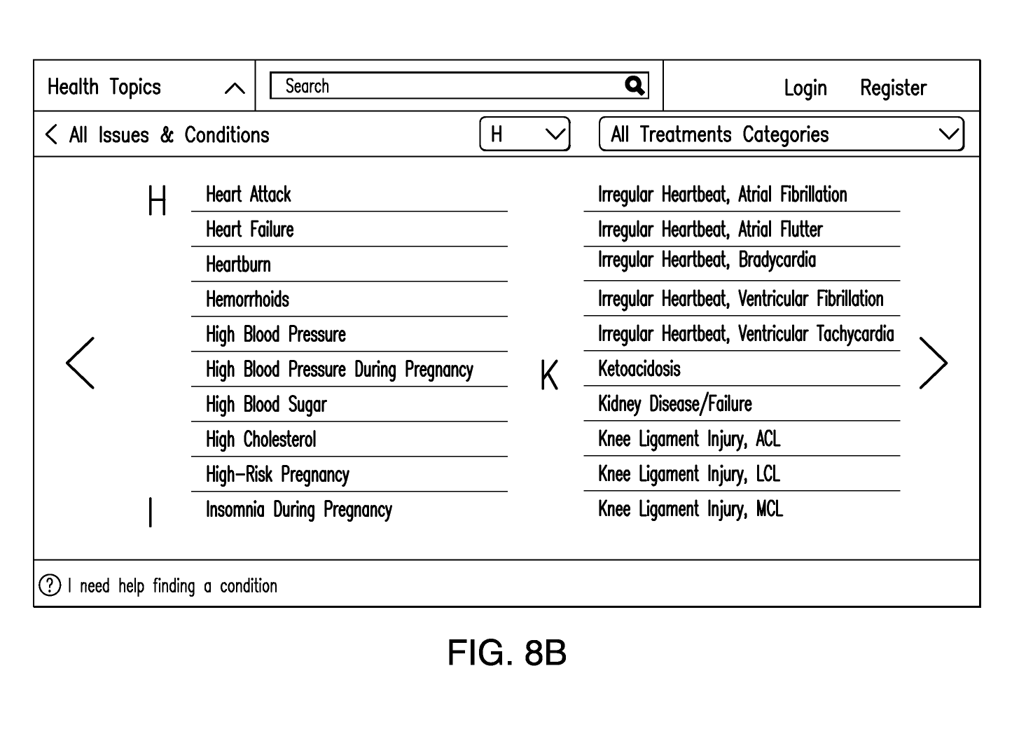

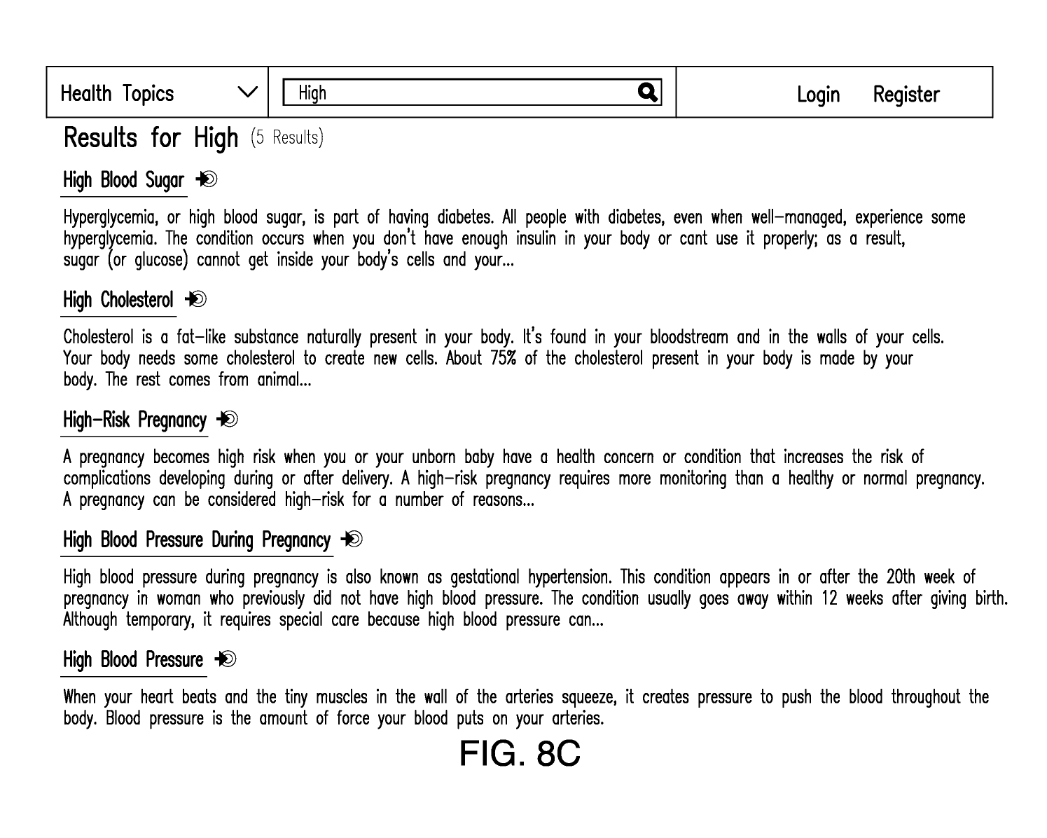

In some embodiments, the process 300 may include a step 304 in which the computer 210 transmits the conditions 214 to a remote device 104. In some embodiments, the conditions 214 may be transmitted to the remote device 104 via the network interface 208 and the network 106. In some non-limiting embodiments, the remote device 104 may display the transmitted conditions 214 to a user of the remote device 104 (e.g., via a user interface such as, for example, as shown in FIGS. 8A-8C).

In some embodiments, the process 300 may include a step 306 in which the computer 210 receives an identification of a condition from the remote device 104. In some embodiments, the identification of the condition may be received from the remote device 104 via the network 106 and the network interface 208. In some embodiments, the identified condition may be one of the conditions 214. In some non-limiting embodiments, the identified condition may be a condition of the conditions 214 that was selected by a user of the remote device 104 (e.g., via a user interface).

In some embodiments, the process 300 may include a step 308 in which the computer 210 receives an identification of potential treatments for the identified condition from the storage device 212. In some non-limiting embodiments, the received identification of treatments may identify a portion or subset of the potential condition treatments 216 stored in the storage device 212 (i.e., the portion or subset of the potential condition treatments 216 that are for treating the identified condition). In some non-limiting embodiments, step 308 may include requesting the treatments of the potential condition treatments 216 that are for treating the identified condition and receiving the identification of treatments for the identified condition from the storage device 212.

In some embodiments, the process 300 may include a step 310 in which the computer 210 receives treatment information about the identified treatments from the storage device 212. In some non-limiting embodiments, the received treatment information may include a portion or subset of the treatment information 218 stored in the storage device 212 (i.e., the portion or subset of the treatment information 218 about the identified treatments). In some non-limiting embodiments, the received treatment information includes one or more of an indication of the clinical effectiveness of the identified treatments, data characterizing experiences of patients with the identified treatments, information about the cost of the identified treatments, and information about insurance coverage for the identified treatments. In some non-limiting embodiments, step 310 may include requesting treatment information of the treatment information 218 that is about the identified treatments and receiving the treatment information about the identified treatments from the storage device 212.

In some embodiments, the process 300 may include a step 312 in which the computer 210 generates initial rankings of the identified treatments based on the received treatment information. In some non-limiting embodiments, the initial rankings may be generated for a hypothetical typical person. In one non-limiting embodiment, the typical person initial rankings may be characterized by analysis of the typical patient in the information about patients and treatments outcomes 220 who reported having that condition. For example, in one embodiment, the analysis may be via average characteristics or median characteristics fed into a predictive algorithm that ranks treatments using a combination of statistical methods and a rules-database of medical guidelines. In some non-limiting embodiments, the typical patient rankings are generated by statistical analysis of the entire dataset in the information about patients and treatments outcomes 220 that is related to patients that have had one of the identified treatments for the identified condition, and then adjusted by based on clinical treatment guidelines, clinical evidence, and/or other factors.

In some embodiments, the process 300 may include a step 314 in which the computer 210 transmits the initial rankings to the remote device 104. In some embodiments, the initial rankings may be transmitted to the remote device 104 via the network interface 208 and the network 106. In some non-limiting embodiments, the remote device 104 may display the initial rankings to a user of the remote device 104 (e.g., via a user interface).

In some embodiments, the process 300 may include a step 316 in which the computer 210 receives patient information identifying one or more characteristics of a patient from the remote device 104. In some embodiments, the patient information may be received from the remote device 104 via the network 106 and the network interface 208. In some non-limiting embodiments, the patient information may be received from a user of the remote device 104 (e.g., via a user interface). In some embodiments, the patient information may include information about a patient having the identified condition for which a treatment is intended. In some non-limiting embodiments, the patient information may include one or more of clinical information and non-clinical information.

In some embodiments, the clinical information may include one or more of condition status information, demographic information, a previous condition of the patient, a current condition of the patient, and allergies of the patient. The condition status information may include an identification of one or more of the severity of the identified condition in the patient and the length of time that the patient has had the identified condition. The demographic information may include an identification of one or more of the gender of the patient, the race or ethnicity of the patient, the age of the patient, the height of the patient, the weight of the patient, the household income of the patient, the level of education achieved by the patient, the extent to which the patient's job is physically demanding, and whether the patient is a medical professional.

In some embodiments, the non-clinical information may include one or more of treatment preference information, treatment value information, willingness information, and information about one or more behaviors of the patient. The treatment preference information may include an identification of one or more treatments that the patient is currently using or leaning towards using for the identified condition. The treatment value information may include an identification of the extent to which the patient values one or more of treatment effectiveness, how quickly a treatment works, treatment cost, treatment popularity of the treatment, and the side effects of a treatment when choosing a treatment. The willingness information may include an identification of one or more of the extent to which the patient is willing to take prescription medications, the extent to which the patient is willing to use alternative medicine therapies, and the extent to which the patient is willing to undergo surgery or other invasive treatments. The one or more behaviors of the patient may include one or more risk behaviors, such as, for example and without limitation, whether or how frequently the patient smokes, whether or how frequently the patient exercises, whether or how frequently the drinks alcohol, and/or the patient's dietary habits, etc.

In some embodiments, the process 300 may include a step 318 in which the computer 210 generates updated rankings of the identified treatments based on the received treatment information and the received patient information. In some non-limiting embodiments, generating the updated rankings of the identified treatments in step 318 may include the computer 210 ranking the identified treatments from the identified treatment most likely to be a good match for the patient to the identified treatment least likely to be a good match for the patient based on the received patient information. In some embodiments, the computer 210 may use a model based on one or more advanced statistical and/or machine learning techniques to rank the identified treatments. In some embodiments, in ranking the identified treatments, the computer 210 may additionally or alternatively use a statistical algorithm to impute information about the patient not that was not provided by the patient based on information that was provided by the patient. In some non-limiting embodiments, a match is a direct prediction of a likely patient satisfaction with the treatment based on other patients' satisfaction scores for the treatment. In some non-limiting embodiments, the direct prediction may be combined with medical guidelines, evidence, effectiveness ratings, popularity, and/or relevance of treatments.

In some non-limiting embodiments, generating the updated rankings of the identified treatments in step 318 may include using a predictive matching algorithm to analyze the one or more characteristics of the patient identified by the received patient information against the information contained in the database and to generate predictions of the likelihood that the patient will consider the outcome of each of the identified treatments successful. In some embodiments, if the received patient information includes an identification of more than one characteristic of the patient (e.g., if the patient information includes an age range of the patient, an indication that the patient is willing to undergo surgery or other invasive treatment), the computer 210 may determine which characteristic made the greatest contribution to the changes in the treatment rankings.

In some embodiments, the process 300 may include a step 320 in which the computer 210 transmits the updated rankings to the remote device 104. In some embodiments, the updated rankings may be transmitted to the remote device 104 via the network interface 208 and the network 106. In some non-limiting embodiments, the remote device 104 may display the updated rankings to a user of the remote device 104 (e.g., via a user interface).

In some embodiments, the process 300 may include a step 322 in which the computer 210 determines whether the computer 210 received additional patient information identifying one or more additional characteristics of the patient (and/or one or more changes to the previously received patient information) from the remote device 104. In some embodiments, the computer 210 may receive the additional patient information from the remote device 104 via the network 106 and the network interface 208. In some non-limiting embodiments, the additional patient information may be received from a user of the remote device 104 (e.g., via a user interface). If the computer 210 determines that the computer 210 received additional patient information, the process 300 may repeat steps 318 and 320 in which the computer 210 generates further updated rankings of the identified treatments based on the treatment information, the previously received patient information, and the received additional patient information and transmits the further updated rankings to the remote device 104. In some non-limiting embodiments, the remote device 104 may display the updated rankings to a user of the remote device 104 (e.g., via a user interface).

For example, in one non-limiting embodiment, if the computer 210 receives an identification of a high blood pressure condition from a remote device 104 in step 306, the computer 210 may then request an identification of potential treatments for the high blood pressure condition from the storage device 212. In step 308, the computer 210 may receive an identification of the high blood pressure treatments of the potential condition treatments 216 stored in storage device 212. In step 310, the computer may receive treatment information about the identified high blood pressure treatments from the storage device 212. In step 312, the computer 210 may generate initial rankings of the identified high blood pressure treatments based on the received treatment information. In step 314, the computer 210 may transmit the initial high blood pressure treatment rankings to the remote device 104. In step 316, the computer 210 may receive patient information identifying one or more characteristics of a patient having high blood pressure from the remote device 104. In step 318, the computer 210 may generate updated rankings of the identified high blood pressure treatments based on the received treatment information and the received patient information. In step 320, the computer may transmit the updated high blood pressure treatment rankings to the remote device 104. In this way, the computer 210 may generate a treatment recommendation tailored to the specific patient having the condition.

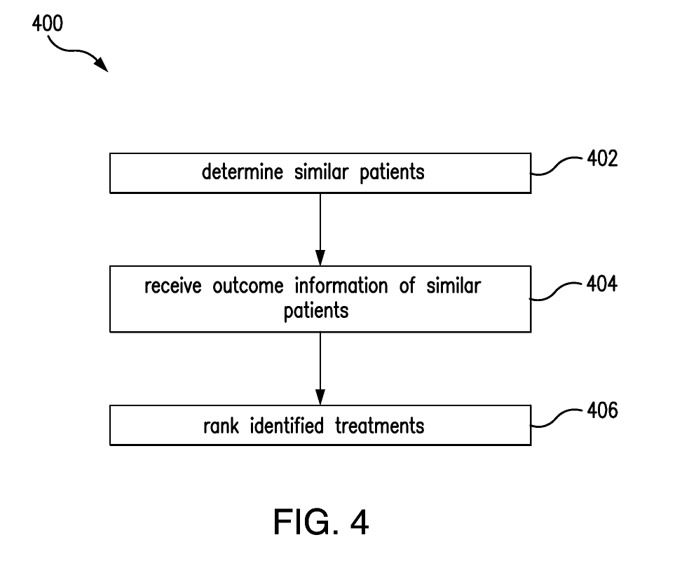

FIG. 4 is a flow chart illustrating the process 400 for updating the treatment rankings according to some non-limiting embodiments. In some embodiments, the process 400 may be performed by the computer 210 during step 318 of the process 300 for recommending treatments. In some embodiments, the process 400 may begin in step 402 with the computer 210 determining one or more patients that are similar to the patient described by the patient information. In some non-limiting embodiments, determining one or more similar patients may include the computer 210 accessing (e.g., querying) the information about patients and treatment outcomes 220 in the storage device 212 to identify which of the patients (i) have or had the identified condition, (ii) have had one or more of the identified treatments on the identified conditions, and (iii) have one or more characteristics that are the same as or similar to the one or more characteristics of the patient identified by the patient information.

In some embodiments, the process 400 may include a step 404 in which the computer 210 receives outcome information for the one or more of the identified treatments used on the identified condition for the one or more patients determined to be similar. In some non-limiting embodiments, in step 404, the computer 210 may access (e.g., query) the information about patients and treatment outcomes 220 in the storage device 212 for the information about the outcomes of the identified treatments on the identified condition of the similar patients. In some non-limiting embodiments, the received outcome information may include one or more ratings by patients or doctors of how successful a treatment of the identified treatments was at treating the identified condition. In some non-limiting embodiments, the received outcome information may additionally or alternatively include one or more ratings by patients or their caregivers relating their overall recommendation or satisfaction with the treatment, and the ratings may take into account factors such as cost, speed, side effects, and/or difficulty in addition to effectiveness.

In some embodiments, the process 400 may include a step 406 in which the computer 210 ranks the identified treatments based on the treatment information and the received outcome information for the identified treatments on similar patients. In some non-limiting embodiments, in ranking the identified treatments, the computer 210 may give increased weight to the outcomes of similar patients that are most similar to the patient (as described by the received patient information). In some non-limiting embodiments, ranking the identified treatments may include, for each outcome in the received outcome information, weighting the outcome based upon the degree to which the one or more characteristics of the patient identified by the received patient information matches one or more characteristics of the similar patient of the similar patients having the outcome.

In some non-limiting embodiments, ranking the identified treatments may include generating, for each of the similar patients, a confidence level that the similar patient is representative of the patient based upon the degree to which the one or more characteristics of the patient identified by the received patient information matches one or more characteristics of the similar patient. In one embodiment, generating the confidence level may include using a nearest neighbor ranking between the user patient and the patients in the database and assessing how dense the user patient's neighborhood is in relation to a benchmark. In some embodiments, the confidence level may be a statistical validity (like a p-score) that represents the likelihood that, given the current set of training data, a given training input, if removed from the training set, would be properly predicted by the model.

In some non-limiting embodiments, ranking the identified treatments may include generating a normalized score for each of the treatments for a condition. Generating a normalized score may include creating a score for each of the treatments for a condition and re-normalizing the scale so that the highest ranking treatment is the top of the scale and the lowest ranking treatment is the bottom of the scale. In one embodiment, generating the normalized score may include setting the score of the lowest ranking treatment to 0, setting the score of the highest ranking treatment to 1, and then assigning proportional scores between 0 and 1 to all other treatments. In some embodiments, the normalized score may be the output of a machine learning process designed to balance the weight of medical rules, patient recommendations, and usage.

In some embodiments, ranking the identified treatments may include predicting the user's satisfaction with each of the treatments for the condition. In some non-limiting embodiments, when the computer 210 predicts treatment satisfaction, the computer 210 may use a two-dimensional scale. The first dimension may be the qualitative prediction on a five point scale (e.g., very satisfied, not satisfied, etc.). The second dimension may be a confidence level for the prediction (e.g., 0-1.0 scale), which may, for example, be based on a statistical test for confidence. In one embodiment, to rank the treatments, the computer 210 may first rank by the qualitative dimension and then adjust the rank by confidence within that dimension by using confidence as a weighting factor in creating the final ranking score.

In a non-limiting example illustrating the operation of the computer 210 of the treatment recommendation computer system 102 according to one embodiment, the computer 210 may receive an identification of a high blood pressure condition from a remote device 104 in step 306 and patient information identifying that the patient is male, weighs 350 pounds, is willing to take prescription medicine, and wants a popular treatment that works quickly from the remote device 104 in step 316. In step 402, the computer 210 may determine similar patients querying the information about patients and treatment outcomes 220 in the storage device 212 for patients that (i) have or had the high blood pressure, (ii) have had one or more of the identified high blood pressure treatments, and (iii) have one or more characteristics that are the same as or similar to 350 pound weight, willing to take prescription medicine, values popular treatments, and values quick effectiveness characteristics identified by the patient information. In step 404, the computer 210 may receive outcome information for the one or more of the identified high blood pressure treatments used on one or more of the similar patients. In step 406, the computer 210 may rank the identified high blood pressure treatments based on the received outcome information and treatment information about the identified high blood pressure treatments. In some non-limiting embodiments, if the outcome information includes (i) a positive outcome (e.g., a highly satisfied patient rating) for the beta blocker treatment on the high blood pressure condition of a first similar patient who is male, weighs 365 pounds, is willing to take prescription medicine, and has not expressed on opinion on treatment popularity and (ii) a negative outcome for the beta blocker treatment on the high blood pressure condition of a second similar patient who is female, weighs 345 pounds, has not expressed on opinion on prescription drugs, and wants a popular treatment, the computer 210 may give more weight to the positive outcome than the negative outcome in ranking the high blood pressure treatments because the patient (as described by the received patient information) is more similar to the first similar patient than to the second similar patient.

In another non-limiting example, if the outcome information includes (i) a positive outcome for the beta blocker treatment on the high blood pressure condition of a patient who reports they a positive inclination towards prescription drugs and (ii) a positive outcome for the “exercise” treatment on the high blood pressure condition of a patient who reports a negative inclination towards prescription drugs, the computer 210 may bias the rankings towards “exercise” for a patient who reports a negative inclination towards prescription drugs. Accordingly, in some embodiments, a patient's personal preferences as expressed in the patient information may influence the treatment rankings (e.g., based on the outcome information for one or more patients who have reported a similar personal preference).

In some embodiments, although not shown in FIG. 3, the process 300 may include a step of receiving a selection of a treatment from the remote device 104 (e.g., via the network 106 and the network interface 208). The received treatment selection may identify one of the treatments for the identified condition. In some non-limiting embodiments, in response to receiving the treatment selection, the computer 210 may request and receive detail information about the selected treatment from the storage device 212. For example, in one embodiment, the detail information may be part of the treatment information 218. In some non-limiting embodiments, the detail information includes one or more of a description of the selected treatment, the popularity of the selected treatment with patients that have used the selected treatment, the effectiveness of the selected treatment with patients that have used the selected treatment, clinical evidence of effectiveness of the selected treatment, potential side effects of the selected treatment, potential impacts on work of the selected treatment, speed of effectiveness of the selected treatment, out-of-pocket costs of the selected treatment, total costs of the selected treatment, and potential pain of the selected treatment. In some embodiments, the computer 210 may transmit the detail information for the selected treatment to the remote device 104 (e.g., via the network interface 208 and the network 106), which may display the information to a user of the remote device 104 (e.g., via a user interface).

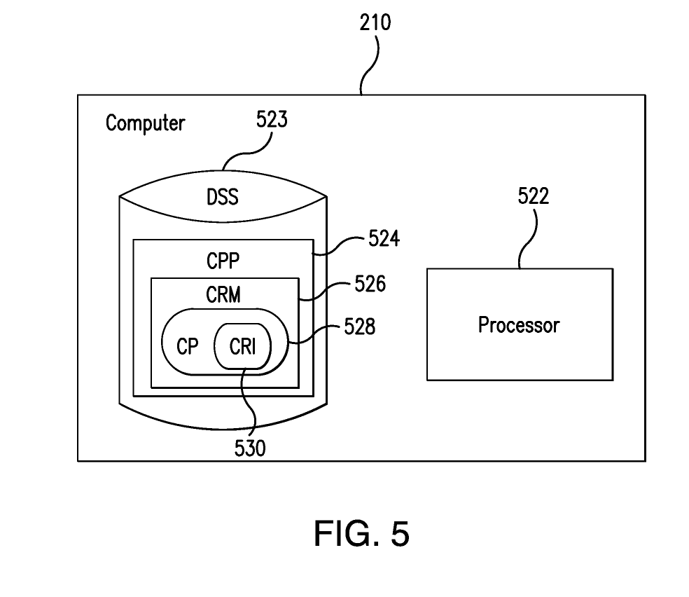

FIG. 5 is a block diagram of a non-limiting embodiment of the computer 210 of the treatment recommendation computer system 102. As shown in FIG. 5, the computer 210 may include one or more processors 522 (e.g., a general purpose microprocessor) and/or one or more circuits, such as an application specific integrated circuit (ASIC), field-programmable gate arrays (FPGAs), a logic circuit, and the like. In some embodiments, the computer 210 may include a data storage system (DSS) 523. The DSS 523 may include one or more non-volatile storage devices and/or one or more volatile storage devices (e.g., random access memory (RAM)). In embodiments where the computer 210 includes a processor 522, the DSS 523 may include a computer program product (CPP) 524. CPP 524 may include or be a computer readable medium (CRM) 526. The CRM 526 may store a computer program (CP) 528 comprising computer readable instructions (CRI) 530. CRM 526 may be a non-transitory computer readable medium, such as, but not limited, to magnetic media (e.g., a hard disk), optical media (e.g., a DVD), solid state devices (e.g., random access memory (RAM) or flash memory), and the like. In some embodiments, the CRI 530 of computer program 528 may be configured such that when executed by processor 522, the CRI 530 causes the computer 210 to perform steps described above (e.g., steps described above with reference to the flow charts shown in FIGS. 3 and 4). In other embodiments, the computer 210 may be configured to perform steps described herein without the need for a computer program. That is, for example, the computer 210 may consist merely of one or more ASICs. Hence, the features of the embodiments described herein may be implemented in hardware and/or software.

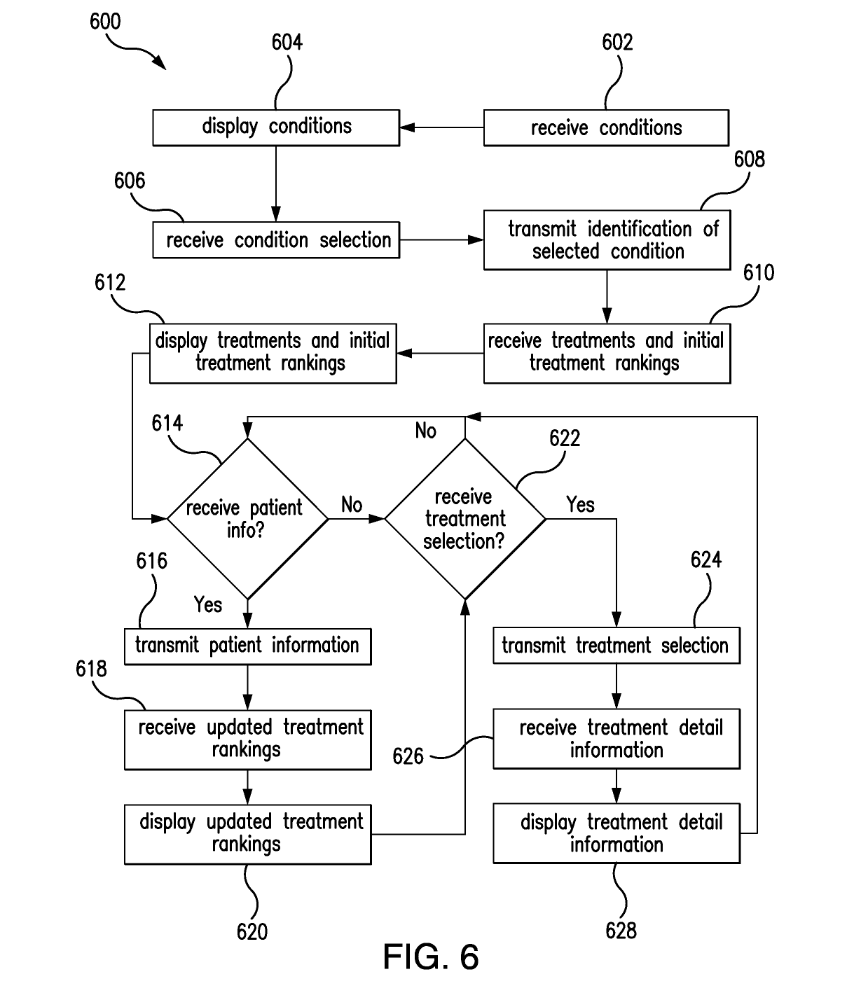

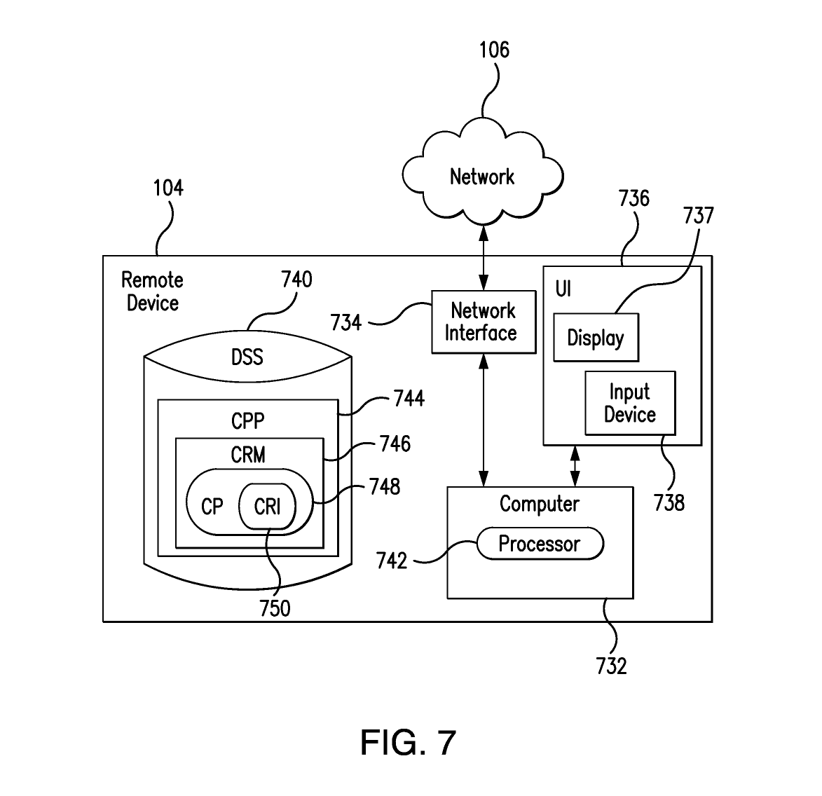

FIG. 6 is a flow chart illustrating a process 600 for recommending treatments according to some embodiments. FIG. 7 is a block diagram of an embodiment of a remote device 104 that may perform the process 600. As shown in FIG. 7, the remote device 104 may include one or more of: a computer 732, a network interface 734, a user interface (UI) 736, and a data storage device (DSS) 740. The computer 732 may include one or more processors 742 (e.g., a general purpose microprocessor) and/or one or more circuits, such as an application specific integrated circuit (ASIC), field-programmable gate arrays (FPGAs), a logic circuit, and the like. The network interface 734 may connect the remote device 104 to the network 106. In some embodiments, the user interface 736 may include a display 737 and/or an input device 738. The display 737 may include one or more display screens and/or one or more speakers. In some non-limiting embodiments, the input device 738 may include one or more of a mouse, touchpad, keyboard, stylus, microphone, and touchscreen. In some embodiments, a user (e.g., a patient, patient caregiver, or patient family member) may receive and/or input information through the user interface 736.

In some embodiments, the process 600 may begin in step 602 with the computer 732 receiving conditions 214 from the treatment recommendation computer system 102. In some embodiments, the conditions 214 may be received from the treatment recommendation computer system 102 via the network 106 and the network interface 734.

In some embodiments, the process 600 may include a step 604 in which the computer 732 displays one or more of the conditions 214. In some non-limiting embodiments, the computer 732 may display one or more of the conditions 214 to the user of the remote device 104 via the display 737 of the user interface 736. For example, as shown in FIGS. 8A and 8B, in one non-limiting embodiment, the computer 732 may display a list of conditions (e.g., in alphabetical order) on the display 737. In a non-limiting embodiment, the computer 732 may additionally or alternatively display one or more conditions as search results in response to the user entering one or more search terms into a search box. For example, as illustrated in FIG. 8C, the computer 732 may display conditions (e.g., “high blood sugar,” “high cholesterol,” “high-risk pregnancy,” “high-blood pressure during pregnancy,” and “high blood pressure”) as search results on the display 737 in response to the user of the remote device 104 entering the search term “high” (e.g., via input device 738) into a search box displayed on display 737. In some non-limiting embodiments, the computer 732 may receive a condition display program from the treatment recommendation computer system 102 and use the condition display program to display the conditions on the display 737. For instance, in some non-limiting embodiments, the computer 732 may run a condition display program to display one or more of the conditions in a drop-down menu on a display 737. In one non-limiting embodiment, the drop-down menu may present a list of conditions and/or conditions by categories and/or may include an embedded search box.

In some embodiments, the process 600 may include a step 606 in which the computer 732 receives an identification of a condition (e.g., high blood pressure). In some embodiments, the identified condition may be one of the displayed conditions 214. In some non-limiting embodiments, a user may select a condition via the input device 738 of the user interface 736 (e.g., by clicking on a displayed condition), and the computer 732 may receive an identification of the selected condition via the input device 738.

In some embodiments, the process 600 may include a step 608 in which the computer 732 transmits the identification of the selected condition to the treatment recommendation computer system 102. In some non-limiting embodiments, the identification of the selected condition may be transmitted to the treatment recommendation computer system 102 via the network interface 734 and network 106.

In some embodiments, the process 600 may include a step 610 in which the computer 732 receives an identification of potential treatments for the selected condition from the treatment recommendation computer system 102. In some non-limiting embodiments, in step 610, the computer 732 may receive initial rankings of the potential treatments for the selected condition from the treatment recommendation computer system 102. In some embodiments, the treatments and/or initial treatment rankings may be received from the treatment recommendation computer system 102 via the network 106 and the network interface 734.

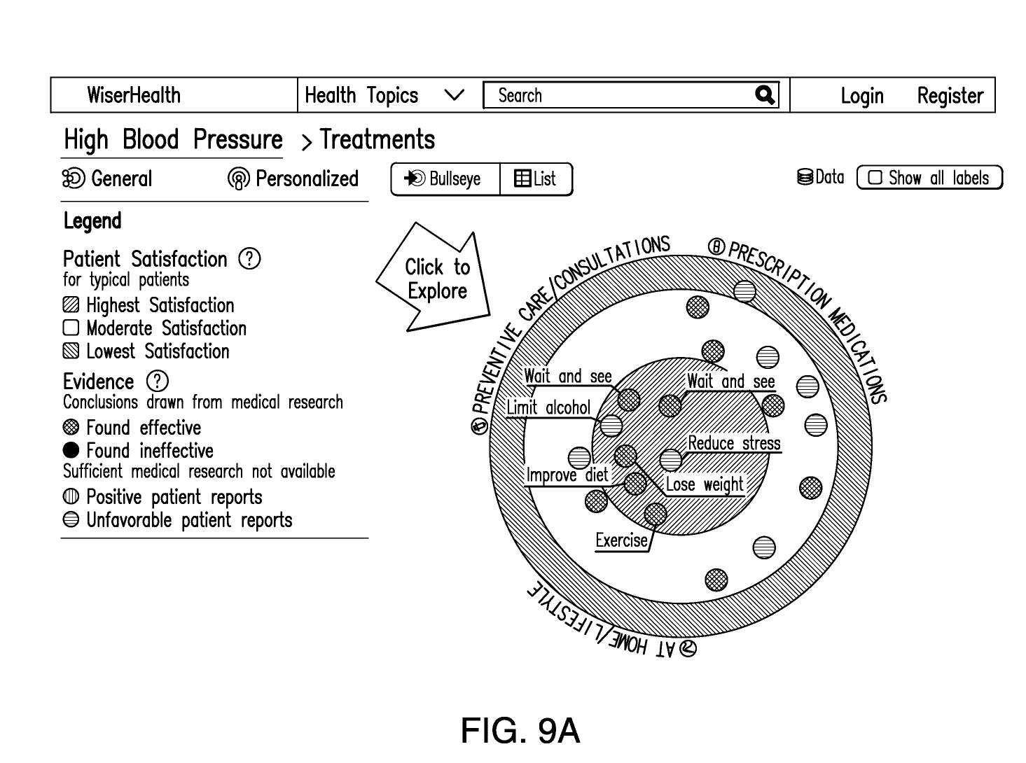

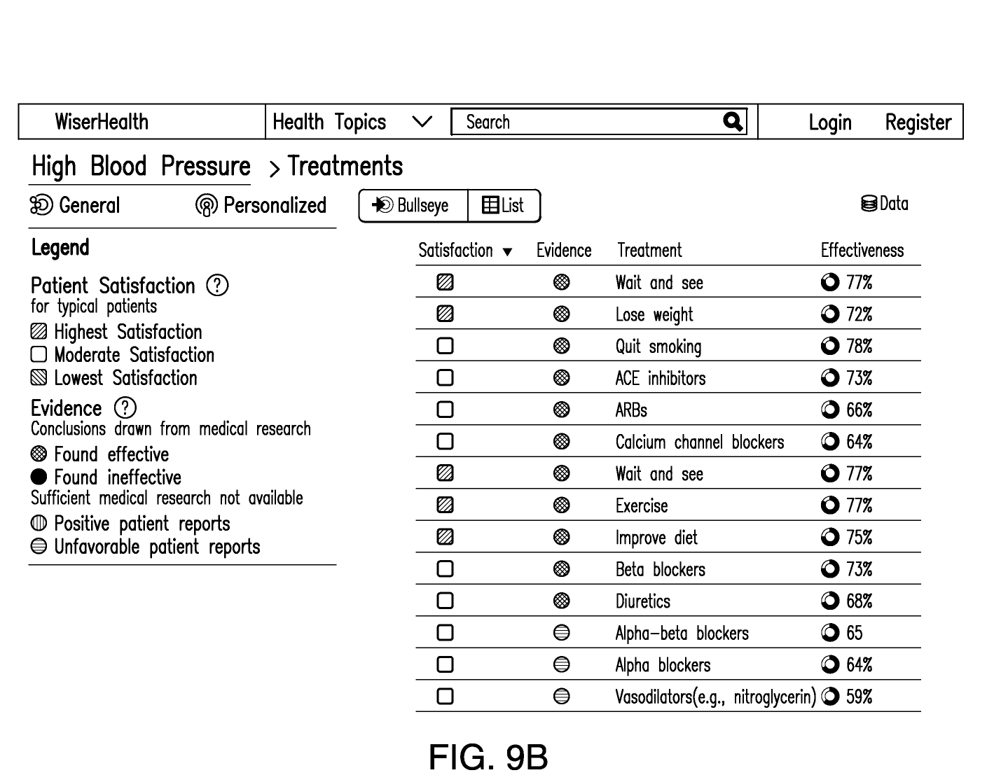

In some embodiments, the process 600 may include a step 612 in which the computer 732 displays a portion or all of the treatments for the selected condition. In some non-limiting embodiments, the computer 732 may display a portion or all of the treatments for the selected condition to the user of the remote device 104 via the display 737 of the user interface 736. In some non-limiting embodiments, the computer 732 may display a portion or all of the treatments according to the initial treatment rankings. For example, in some non-limiting embodiments, the computer 732 may display the received treatments for the selected conditions in accordance with their initial rankings using a “bullseye” graphic, as shown in FIG. 9A, or by listing the high blood pressure treatments in the order of their initial rankings, as shown in FIG. 9B. However, this is not required, and, in alternative embodiments, different graphics or displays may be used to display the received treatments in accordance with their initial rankings.

FIGS. 9A and 9B relate to a specific, non-limiting example where the selected condition is high blood pressure. In some non-limiting embodiments, as shown in FIG. 9A, the bullseye graphic is a radial graphic. The radial graph may include a representation of one or more of the treatments. For example, as shown in FIG. 9A, treatments may be represented as circular spots or bubbles on the radial graph. However, bubbles are not required, and, in alternative embodiments, conditions may be represented by one or more other shapes (e.g., ovals, squares, rectangles, diamonds, crosses, x's, or dots). The position of a treatment bubble on the radial graphic may be an indication of the treatment's rank. For example, the distance of a treatment bubble from the center (i.e., bullseye) of the radial graphic may indicate the treatment's rank, with the highest/best ranked treatments having positions closest to the center. In some non-limiting embodiments, the radial graphic may be divided into two or more radial regions. For example, as shown in FIG. 9A, the bullseye graphic may include an outer region for the weakest/lowest ranked treatments, an intermediate region for moderately ranked treatments, and a central region for the best/highest ranked treatments.

In some non-limiting embodiments, the bullseye graphic may be additionally or alternatively divided into segments (much like a pie-chart representation) for different treatment categories. For example, as shown in FIG. 9A, the bullseye graphic may include segments for prescription medication treatments, at home/lifestyle treatments, and preventative care/consultation treatments. However, the bullseye graphic may alternatively or additionally have other categories, such as, for example, supervised treatments or medical device treatments.

In some non-limiting embodiments, the color and/or size of the treatment bubbles may be associated with particular aspects of the treatment. For example, in one non-limiting embodiment, the size or color of the treatment bubble may be indicative of one or more of whether medical research has found the treatment effective or ineffective, whether patient reports for the treatment are positive or unfavorable, and the popularity of the treatment. In some embodiments, a preferred position on the clock-face (e.g., 12 o'clock) may be assigned for ease of display, and whenever a treatment bubble is selected (for example by clicking on the treatment bubble or pausing over it), the bullseye display may rotate around to bring that treatment bubble to the preferred position. In some embodiments, the bullseye may provide a highly engaging user experience, which not only helps users explore their treatment options more easily but provides treatment ranking information.

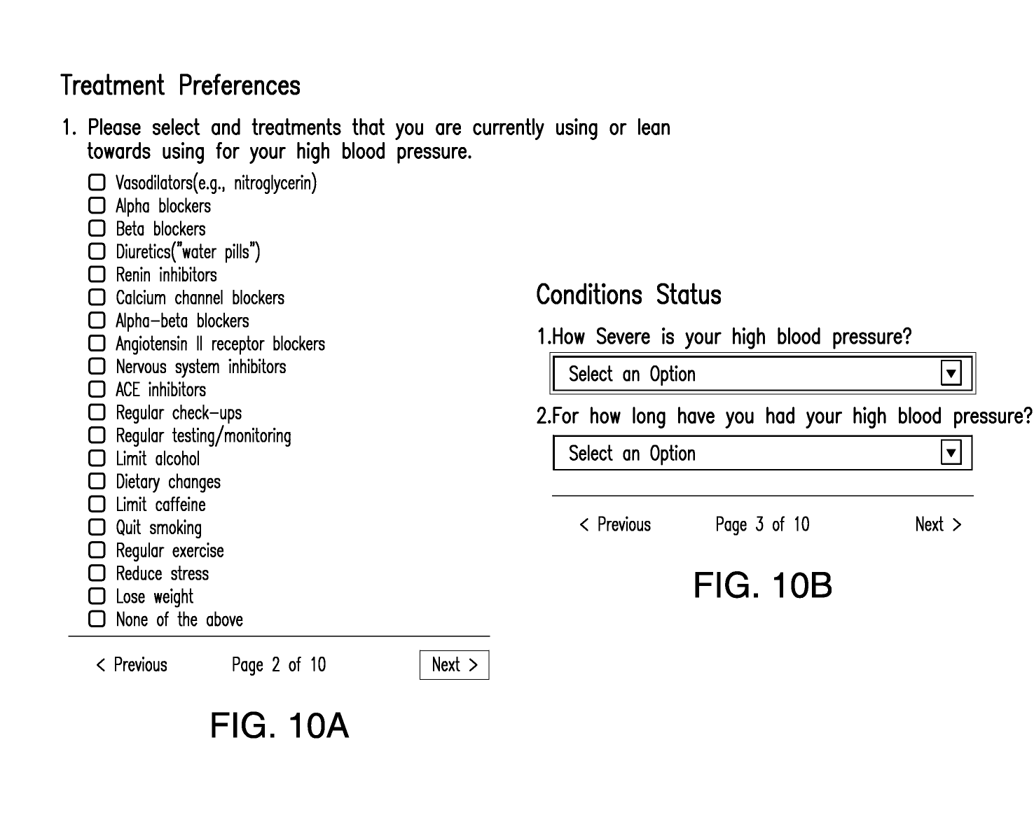

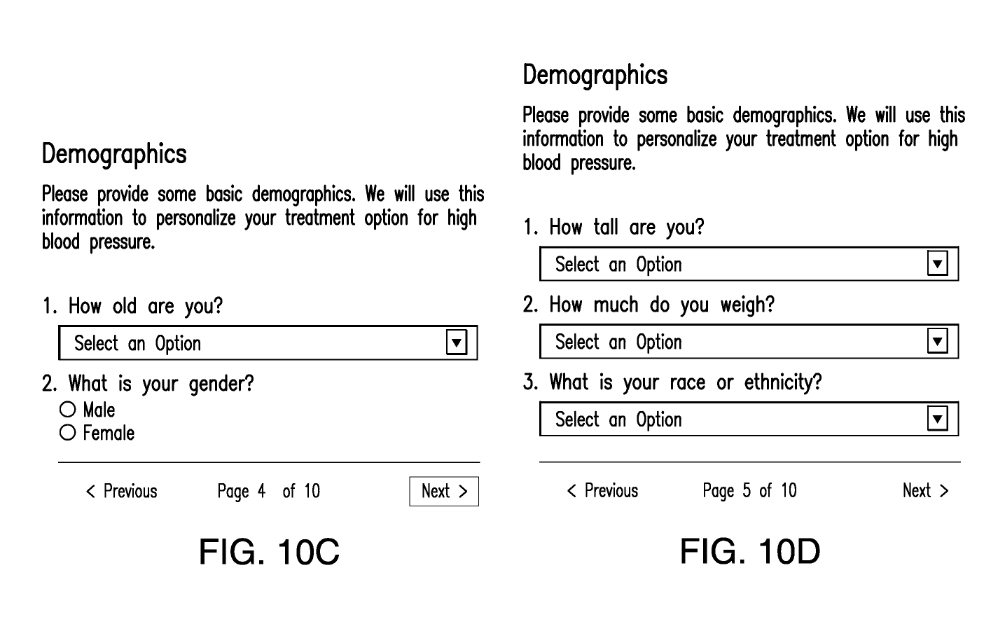

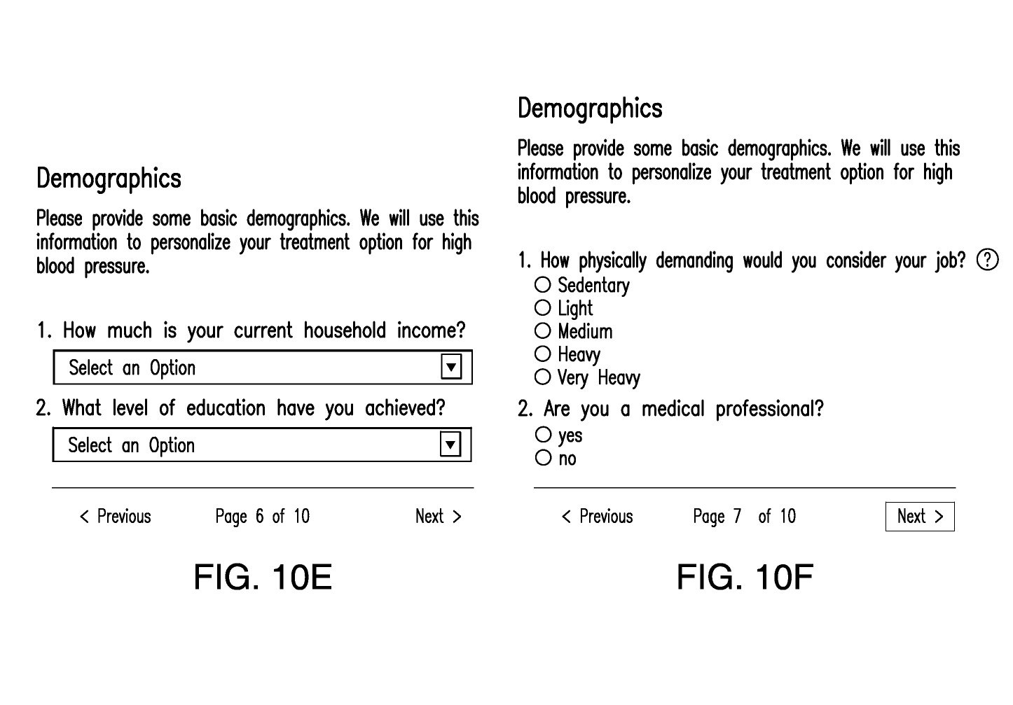

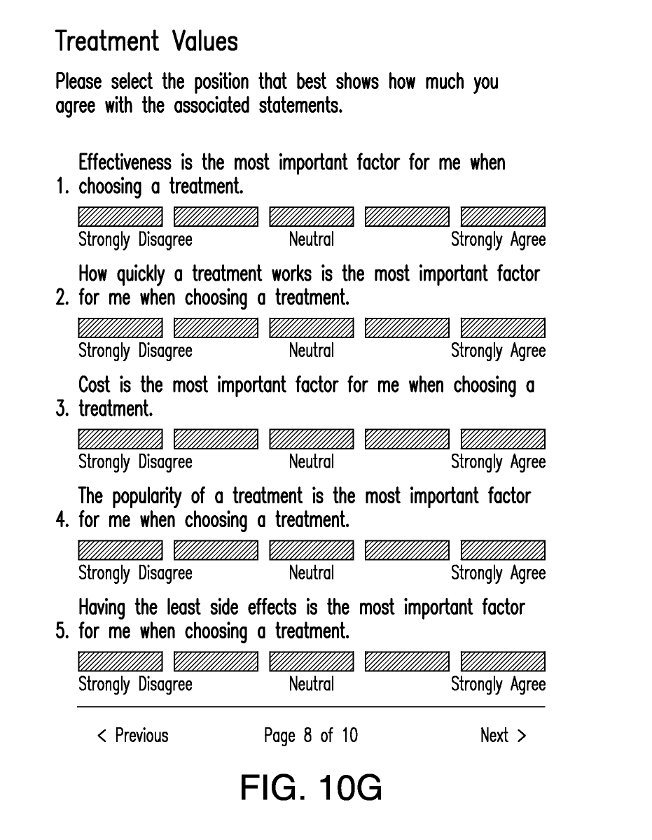

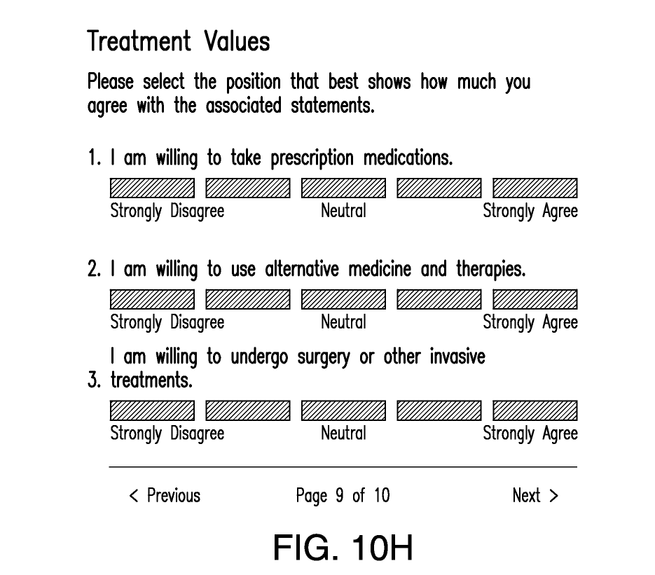

In some embodiments, the process 600 may include a step 614 in which the computer 732 determines whether the computer 732 received patient information identifying one or more characteristics of a patient. In some non-limiting embodiments, the computer 732 may receive the patient information from the input device 738 of the user interface 736. In some non-limiting embodiments, the computer 732 may facilitate user entry of patient information by displaying one or more patient information displays on the display 737. The computer 732 may receive the one or more patient information displays from the treatment recommendation computer system 102. In some embodiments, a patient information display may display one or more questions related to patient information. For example, in one non-limiting embodiment, the computer 732 may display one or more of the patient information displays shown in FIGS. 10A-10H.

As shown in FIG. 10A, in one embodiment, the computer 732 may display (e.g., via display 737) a patient information display asking the user (e.g., a patient or caregiver) whether the patient is currently using or leaning towards using any of the treatments for the identified condition, and the user may enter input (e.g., via input device 738) an identification of one or more of the treatments. As shown in FIG. 10B, in one embodiment, the computer 732 may display a patient information display asking the user how severe the patient's condition is (e.g., mild, somewhat mild, moderate, somewhat severe, or severe) and/or for how long the patient has had the condition (e.g., one time occurrence, less than one week, 2 to 3 weeks, 1 to 2 months, etc.), and the user may skip or enter an answer for the one or more of the questions. As shown in FIGS. 10C-10F, in one embodiment, the computer 732 may display one or more patient information displays asking for demographic information such as, for example, the age of the patient, the patient's gender or sex, the patient's height, the patient's weight, the patient's race or ethnicity, the patient's household income, the patient's level of education, how physically demanding the patient's job is, and/or whether the patient is a medical professional, and the user may skip or enter an answer to one or more of the questions. As shown in FIGS. 10G and 10H, in one embodiment, the computer 732 may display one or more patient information displays asking for treatment value information such as, for example, the importance of treatment effectiveness, the importance of how quickly a treatment works, the importance of treatment cost, the importance of treatment side effects, the patient's willingness to take prescription medications, the patient's willingness to use alternative medicine and therapies, and/or the patient's willingness to undergo surgery or other invasive treatments, and the user may skip or enter an answer to one or more of the questions.

In some embodiments, if the computer 732 determines in step 614 that the computer 732 has received patient information, the process 600 may proceed to a step 616 in which the computer 732 transmits received patient information to the treatment recommendation computer system 102. In some non-limiting embodiments, the patient information may be transmitted to the treatment recommendation computer system 102 via the network interface 734 and network 106.

In some embodiments, the process 600 may include a step 618 in which the computer 732 receives updated treatment rankings from the treatment recommendation computer system 102. In some embodiments, the updated treatment rankings may be received from the treatment recommendation computer system 102 via the network 106 and the network interface 734.

In some embodiments, the process 600 may include a step 620 in which the computer 732 displays a portion or all of the treatments for the selected condition according to the updated treatment rankings. In some non-limiting embodiments, the computer 732 may display the updated treatment rankings to the user of the remote device 104 via the display 737 of the user interface 736. In some non-limiting embodiments, the updated treatment rankings may be displayed on the display 737 using a bullseye graphic or a list, as described above with reference to FIGS. 9A and 9B. In some non-limiting embodiments, displaying the updated treatment rankings may include displaying an animation showing the treatment rankings change from previous rankings to the updated rankings. For example, in one non-limiting embodiment, the animation on the bullseye graphic may show the treatment bubbles moving from their previous positions to their updated positions.

In some embodiments, the process 600 may include a step 622 in which the computer 732 determines whether the computer 732 received an identification of a displayed treatment for the selected condition. In some non-limiting embodiments, a user may select a displayed treatment via the input device 738 of the user interface 736 (e.g., by clicking on a displayed treatment or pausing over it), and the computer 732 may receive an identification of the selected condition via the input device 738.

In some embodiments, if the computer 732 determines in step 622 that the computer 732 has received a treatment selection, the process 600 may proceed to a step 624 in which the computer 732 transmits received treatment selection to the treatment recommendation computer system 102. In some non-limiting embodiments, the treatment selection may be transmitted to the treatment recommendation computer system 102 via the network interface 734 and network 106.

In some embodiments, the process 600 may include a step 626 in which the computer 732 receives treatment detail information from the treatment recommendation computer system 102. In some non-limiting embodiments, the treatment detail information may be received from the treatment recommendation computer system 102 via the network 106 and the network interface 734.

In some embodiments, the process 600 may include a step 628 in which the computer 732 displays a portion or all of the received detail information for the selected treatment. In some non-limiting embodiments, the computer 732 may display the detail information to the user of the remote device 104 via the display 737 of the user interface 736.

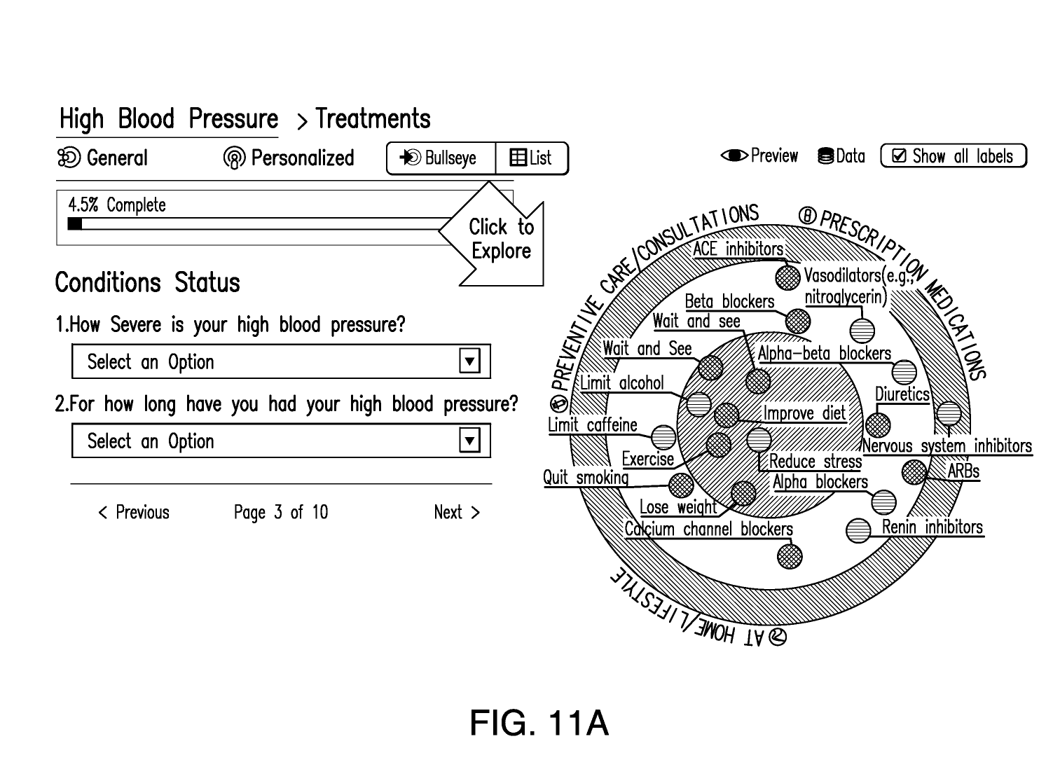

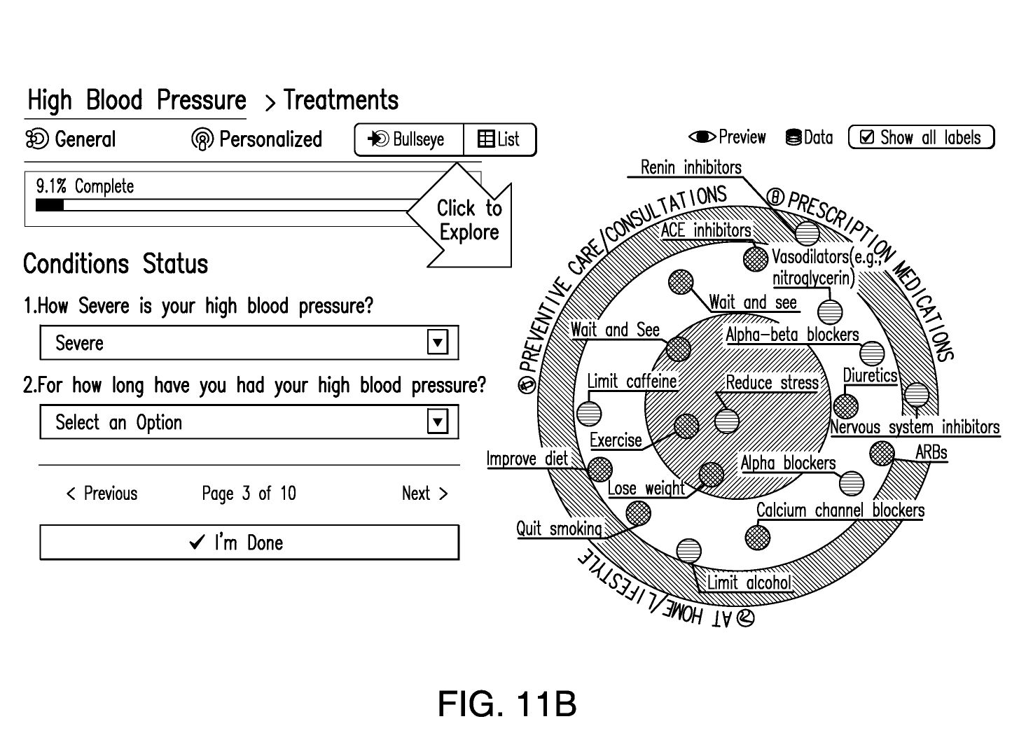

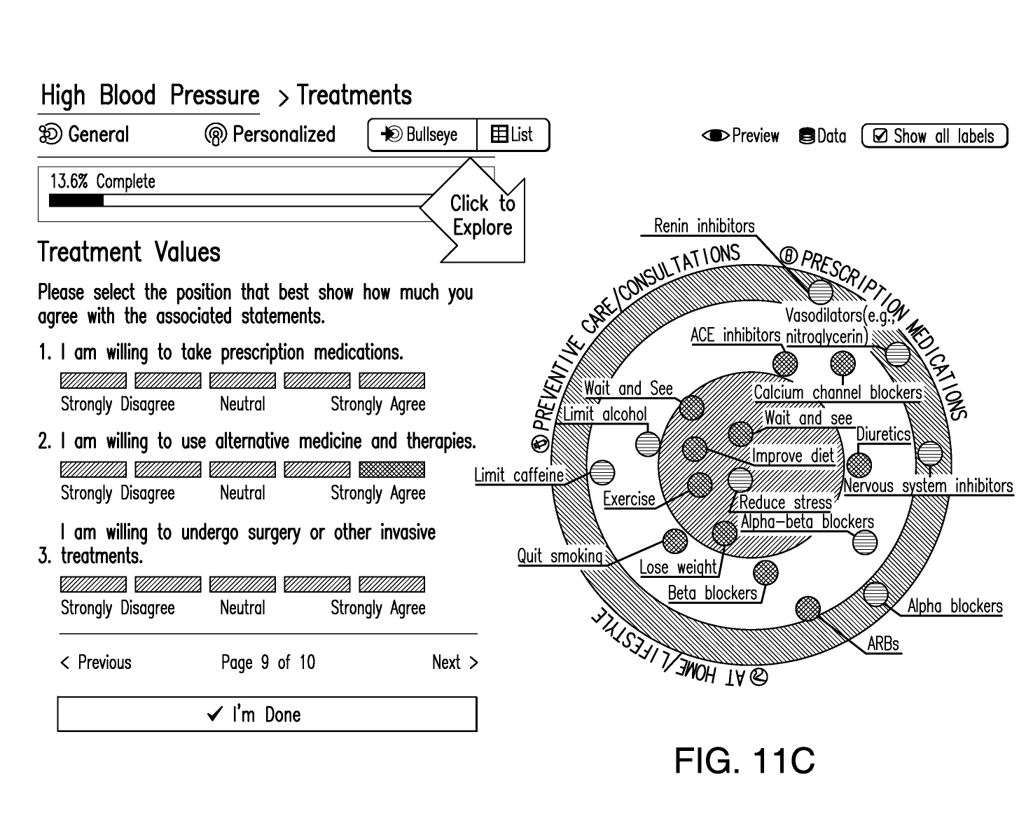

The following is a non-limiting example illustrating the operation of the computer 732 of a remote device 104 according to one embodiment. In the non-limiting example, in step 602, the computer 732 may receive an identification of the high blood pressure condition conditions (e.g., anemia, anorexia, bipolar disorder, etc.) from the treatment recommendation computer system 102. In step 604, the computer 732 may display one or more of the received conditions on the display 737 (e.g., as an alphabetical list as shown in FIGS. 8A and 8B, a list by categories of condition, or as search results as shown in FIG. 8C). In the non-limiting example, the user selects the displayed high blood pressure condition via the input device 738 of the user interface 737, and, in step 606, the computer 732 receives an identification of the selected high blood pressure condition. In step 608, the computer 732 may transmit the selected high blood pressure condition to the treatment recommendation computer system 102. In step 610, the computer 732 may receive high blood pressure treatments and initial rankings of the high blood pressure treatments. In step 612, the computer 732 may display the high blood pressure treatments on the display 737 in accordance with their initial rankings (e.g., using a bullseye graphic, such as for example that shown in FIG. 11A, or using a list (see FIG. 9B)). The computer 732 may display one or more of patient information displays, such as, for example, the condition status patient information display shown to the left of the bullseye graphic in FIG. 11A.

As shown in FIG. 11B, the user may input patient information indicating that the patient's high blood pressure is severe. In step 614, the computer 732 may receive the patient information and, in step 616, transmit the patient information to the treatment recommendation computer system 102. In step 618, the computer 732 may receive updated treatment rankings, and, in step 620, the computer 732 may display the high blood pressure treatment in accordance with the updated treatment rankings using a bullseye graphic, such as, for example, the bullseye graphic shown in FIG. 11B, or using a list (see FIG. 9B)). The high blood pressure treatment rankings shown in FIG. 11B have been updated relative to the high blood pressure treatment rankings shown in FIG. 11A. For example, the updated treatment rankings shown in FIG. 11B, which take into account the severity of the patient's high blood pressure, no longer include limit alcohol as a highly ranked treatment (note that the “limit alcohol” treatment bubble has moved out of the inner circle).

As shown in FIG. 11C, the user may then input additional patient information indicating that the patient is willing to use alternative medicine and therapies. The process 600 may loop back to step 614, where the computer 732 may receive the additional patient information and, in step 616, transmit the patient information to the treatment recommendation computer system 102. In step 618, the computer 732 may receive twice updated treatment rankings, and, in step 620, the computer 732 may display the high blood pressure treatment in accordance with the twice updated treatment rankings using a bullseye graphic, such as, for example, the bullseye graphic shown in FIG. 11C, or using a list (see FIG. 9B)). The high blood pressure treatment rankings shown in FIG. 11C have been updated relative to the high blood pressure treatment rankings shown in FIG. 11B. For example, the updated treatment rankings shown in FIG. 11C, which additionally take into account the willingness of the patient to use alternative medicine and therapies, alpha blockers have moved to the poorly ranked outer region, and the second wait and see treatment (i.e., regular testing and monitoring) has joined the first wait and see treatment (i.e., regular checkups with a specialist) as a highly ranked treatment (note that the inner region of FIG. 11C includes two wait and see treatment bubbles).

In some embodiments, if the computer 732 receives answers to multiple patient information questions transmits patient information including an identification of more than one characteristic of the patient (e.g., if the patient information includes an age range of the patient, an indication that the patient is willing to undergo surgery or other invasive treatment), the computer 732 may receive an indication of which characteristic made the greatest contribution to the changes in the treatment rankings from the treatment recommendation computer system 102 and display that information on the display 737.

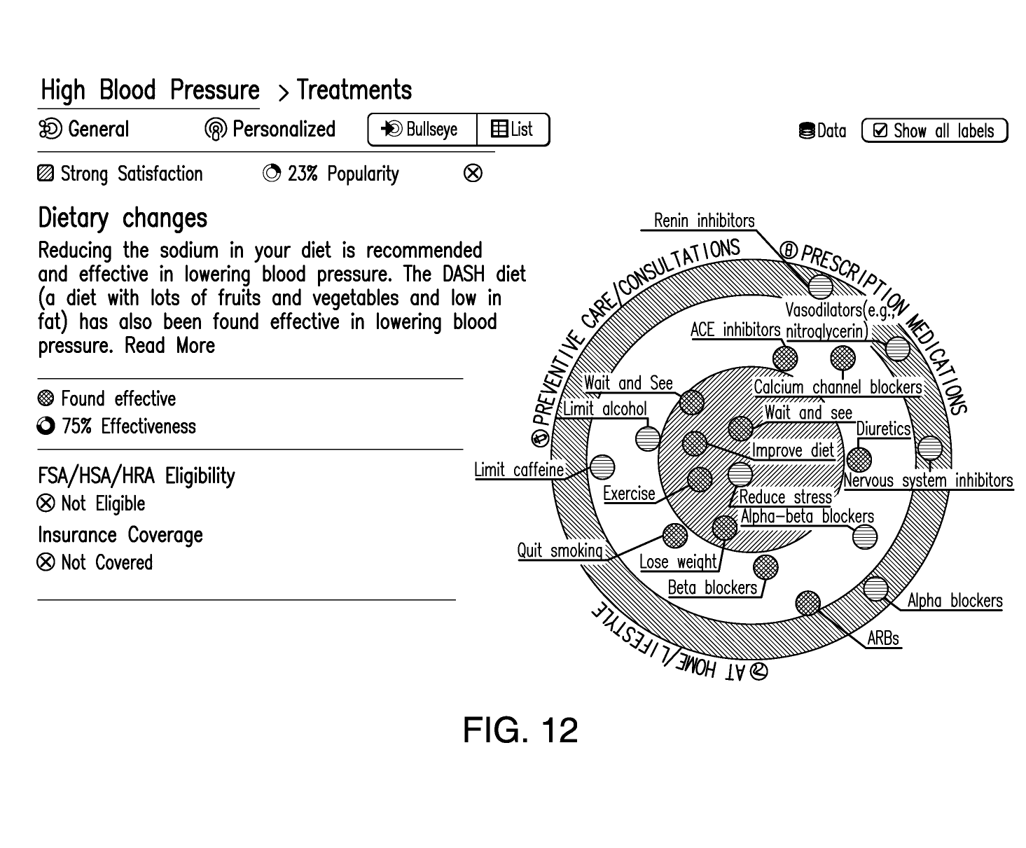

The user of the remote device 104, who may be interested in learning more about the improve diet treatment, may input a selection of the improve diet treatment using the input device 738. In step 622, the computer 732 may receive the treatment selection, and, in step 624, the computer 732 may transmit the treatment selection to the treatment recommendation computer system 102. In step 626, the computer 732 may receive detail information for the improve diet treatment, and, in step 628, the computer 734 may display the detail information for the improve diet treatment. A non-limiting example of a display of detail information for the improve diet treatment is illustrated is shown in FIG. 12 to the left of the bullseye graphic. As shown in FIG. 12, the detail information for the improve diet treatment may include the popularity of the improve diet treatment (23%), an indication that medical research found the improve diet treatment effective, an indication of the effectiveness (75%), and an indication that the improve diet treatment is not covered by insurance.

As illustrated in FIG. 7, the data storage structure (DSS) 740 of the remote device 104 may include one or more non-volatile storage devices and/or one or more volatile storage devices (e.g., random access memory (RAM)). In embodiments where the remote device 104 includes a processor 742, the DSS may include a computer program product (CPP) 744. The CPP 744 may include or be a computer readable medium (CRM) 746. The CRM 746 may store a computer program (CP) 748 comprising computer readable instructions (CRI) 750. CRM 746 may be a non-transitory computer readable medium, such as, but not limited, to magnetic media (e.g., a hard disk), optical media (e.g., a DVD), solid state devices (e.g., random access memory (RAM) or flash memory), and the like. In some embodiments, the CRI 750 of computer program 748 may be configured such that when executed by a processor 742 of computer 732, the CRI 750 causes the remote device 104 to perform steps described above (e.g., steps described above with reference to the flow chart shown in FIG. 6). In other embodiments, the remote device 104 may be configured to perform steps described herein without the need for a computer program. That is, for example, the computer 732 may consist merely of one or more ASICs. Hence, the features of the embodiments described herein may be implemented in hardware and/or software.

In some embodiments, the treatment recommendation computer system 102 may store profile information (e.g., in storage device 212). The profile information may include one or more user profiles. In some embodiments, a user profile may contain patient information entered by a user about the user, where the user is the patient. In some non-limiting embodiments, a user profile may include one or more sub-profiles. A sub-profile may contain patient information entered by the user about a patient, where the patient is someone other than the user. For example, with home use, the patient may be a family member (e.g., spouse or child) or friend of the user. With clinical use, user may be a caretaker (e.g., a physician or nurse), and the patient may be a patient in the caretaker's patient population. In some embodiments, the treatment recommendation computer system 102 provides the user the ability to create and manage a user profile (and one or more sub-profiles). In some embodiments, the treatment recommendation computer system 102 may collect patient information entered by the user and incrementally builds up a health profile of the user, which may be accessed by the user and/or the user's physician. In some embodiments, the treatment rankings may be based on one or more of treatment information, patient information previously stored in a user profile or sub-profile, and newly entered patient information. In some embodiments, the treatment recommendation computer system 102 may enable the user to view and modify previously answers/patient information. The profile system may allow a user to save their answers/entered patient information and later manipulate the answers or reuse them, either for the same condition of another condition. In some non-limiting embodiments, the treatment recommendation computer system 102 will only store patient information entered by the user if the user gives permission.

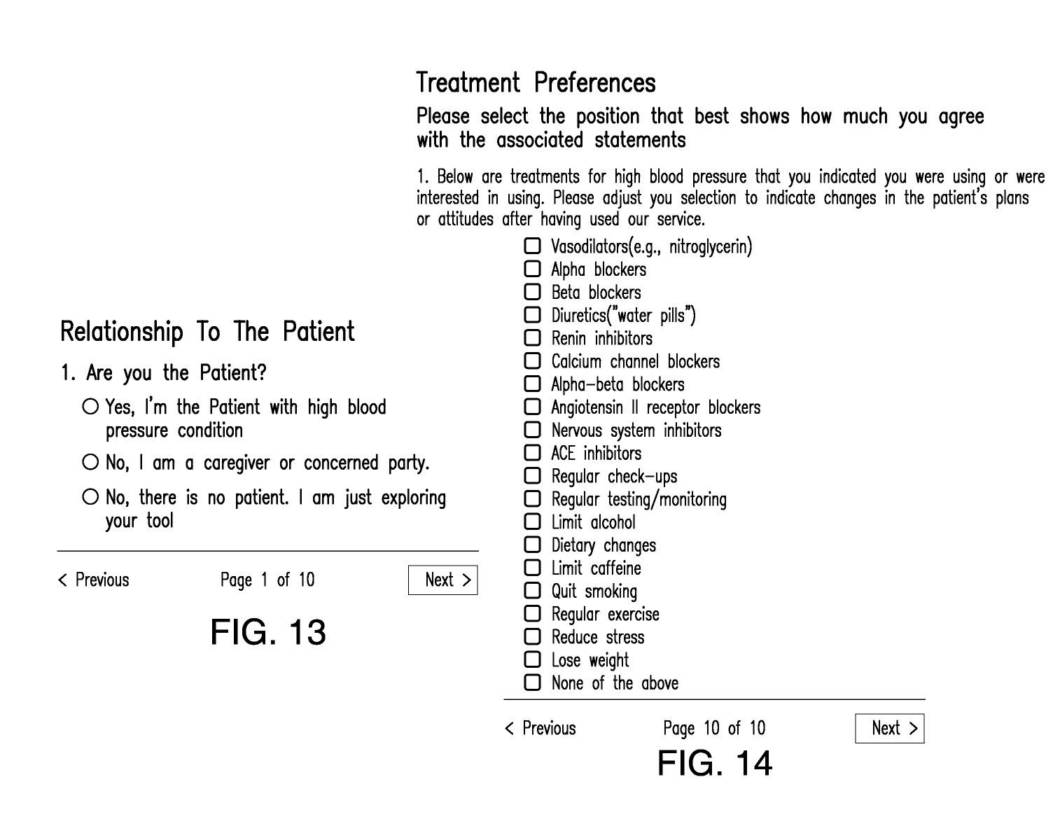

In some embodiments, the computer 732 may display one or more displays asking for the user's relationship to the patient (e.g., the user is the patient, or the user is a caregiver or concerned party), and the user may input an answer (e.g., using input device 738). FIG. 13 illustrates a non-limiting example of such a display. In some embodiments, the computer 732 may receive the user's answer regarding the user's relationship to the patient and transmit the answer to the treatment recommendation computer system 102. Based on the user's answer, the treatment recommendation computer system 102 determine whether any subsequent patient information entered by the user should be stored to the user's profile, stored to a sub-profile, or not stored at all (e.g., to avoid junk information from being stored to a user's profile when the user is simply trying out the system 100).

In some embodiments, the computer 732 may display one or more graphics asking whether the user's plans or attitudes with respect to the treatments for a condition have changed after using the system 100, and the user may enter an answer (e.g., using the input device 738). FIG. 14 illustrates a non-limiting example of a graphic that asks the user whether the user's plans or attitudes with respect to the high blood pressure treatments have changed after using the treatment recommendation system. In some embodiments, the computer 732 may transmit the user's answer to the treatment recommendation computer system 102, and the treatment recommendation computer system 102 may store the information to determine the effectiveness of the system 100 to provide treatment recommendations and influence users' plans and attitudes.

In some embodiments, the computer 210 of the treatment recommendation computer system 102 may configured to perform a medically-oriented content curation process that allows the system to rate how likely medically relevant content is to be useful or of interest to the patient. In some non-limiting embodiments, the curation may occur by tagging content with profile characteristics (e.g., gender, age, severity of condition, interest in alternative medicine, fear of surgery, and/or co-morbidities) of patients who are likely to find the content useful. In some embodiments, curation may occur by having patients rate content and matching the content to users based on both ratings and similarity between the user and the patient raters. In some embodiments, the medically relevant content may be in written or video form or may be content with stories based on other patient's experiences. The treatment recommendation computer system 102 may use the content curation to push useful health content the user (e.g., through the user interface 736 of a remote device 104) without the user having to search for it.

In some embodiments, the computer 210 of the treatment recommendation computer system 102 may configured to perform a transaction process that allows a user who has narrowed down their treatment options and consulted with a relevant professional, to purchase a medical product or service from a list of approved providers who have satisfactorily provided services to patients like them in the past.

In some embodiments, as described above, the system 100 may include a treatment recommendation computer system 102 and one or more remote devices 104 connected to a treatment recommendation computer system 102 via a network 106 (e.g., a real-time network). A remote device 104 may provide a user interface 736 that queries a user of the remote device 104 about the health and personal situation of a patient, who may be, for example, the user or someone for whom the user provides care. The remote device 104 may provide an animated graphical or list display which allows the user to see the impact of their answers on treatment rankings as the patient information is entered, and to explore treatment detail information as it becomes clear what treatments will be most relevant to the particular patient.

In some embodiments, the user may use the system 100 (a) before diagnosis to help plan an appropriate first response, (b) after diagnosis and before treatment to help choose a treatment by narrowing down potential treatments for a condition to a short list of one or more treatments most likely to work satisfactorily for the particular patient, or (c) after treatment has begun to help the patient benchmark their recovery and decide whether their treatment plan should be adjusted. In some embodiments, the computer 210 of the treatment recommendation computer system 102 may perform a predictive matching algorithm capable of taking partial or full patient information from a remote device 104, analyzing it against the information in the storage device 212, and returning predictive information (i.e., treatment rankings) to the remote device 104. In some embodiments, the predictive information includes one or more of (i) confidence levels that the patients in the database are representative of the user/patient, (ii) the relative impact each piece of patient data in the patient information is likely to have on the user's treatment experiences, (iii) a predicted score for things like the user's experienced overall satisfaction, effectiveness, or usage of treatments related to their conditions, (iv) the relevance of the treatment to a patient's in their circumstances; (v) the popularity of a treatment with patients like the patient; and (vi) a ranking of treatments into groups from those most likely to be good overall matches for the patient to those least likely. In some embodiments, the computer 210 of the treatment recommendation computer system 102 may provide treatment detail information including one or more of a speed of effectiveness, a likelihood of patient adherence, side effects, costs, etc. that is personalized using information provided by the user.

In one possible use of the system 100, a patient who believes the patient has a health condition but has not yet begun treatment may use the system 100 on a remote device 104 (e.g., a laptop or mobile device) on the web or a mobile network to narrow down the treatment options and explore a few treatments in depth. The purpose of the process may be to decide what treatment to use or to prepare better for consultation with a professional. The patient may have self-directed to the invention or been referred by friends or family, by a medical professional, an employer or their insurance company. The patient may or may not be offered an incentive to engage with the invention.

In some embodiments, the remote device 104 may display treatment options for the patient's condition (e.g., in a graphic or list) having an initial order or ranking that represents how well different treatments typically match or fit the preferences and situation of typical patients. The graphic or list may also provide access to a variety of information relevant to making a treatment choice, such as, for example, one or more of the clinical evidence about a treatment's effectiveness, data characterizing patient experiences with the treatment, cost information, insurance coverage, and written content describing the uses and medical guidelines related to the treatment. In some embodiments, the user is able to interact directly with treatments on the graphic or list to access this information.

In some embodiments, the user may be able to enter patient information, which may be of a clinical or non-clinical nature. Upon user request, upon advancing to a next patient information question or patient information question set, or upon entry of an answer to a patient information question, the patient information may be submitted to a treatment recommendation computer system 102 having access to a storage device 212 including information about similar patients and their treatment outcomes. A computer 210 of the treatment recommendation computer system 102 may perform a predictive algorithm, and the user of the remote device 104 may be shown an updated version of the treatment list. In some embodiments, the updated treatment list may reorder the treatments to reflect the treatments most likely to be satisfying to the patient given what the system now knows about the patient. In some non-limiting embodiments, various data may also be updated to reflect information about the user and/or curated written or video content may be pushed to the user interface 736 of the remote device 104 based on its relevance.

In some non-limiting embodiments, when the displayed graphic or list updates the treatment rankings based on the patient information, the user may be given one or more messages about the update. In an embodiment, the messages may include educational messages describing the reasons for any changes. For example, if the user has just informed the system 100 that the patient is elderly and some treatments are more recommended for elderly patients, the system may deliver a message informing the user what about the user or treatments triggered the change.

In a second possible use of the system 100, the user may not be the patient but someone who is caring for the patient such as a family member or medical professional. In this use case, the user may create or access a sub-profile representing the patient and enters information or explores on the patient's behalf.

In a third possible use of the system 100, a user may express deepened interest in one particular treatment. In this case, the system 100 allows the user to select the particular treatment (e.g., click on the particular treatment) and undergo a deliberative process to weigh the costs/benefit of using the treatment. In this process, the user may access in-depth data about one or more of patient experiences with treatment side-effects, impacts on work, speed of effectiveness, out-of-pocket costs, total costs, pain, difficulty, and so forth. During the process of accessing this information, the user may be asked to express or adjust their relative tolerances of these treatment risks and costs and balance them against the expected benefits of treatment, to arrive at a more informed opinion about their acceptance of the treatment.

In a fourth use of the system 100, before, during, and after the personalization session, the user may construct a potential treatment plan by moving treatments from the graphic or the list, on and off of a “saved treatments” or “my treatments” list, which will be a permanent place they can refer back to.

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. For example, in some non-limiting embodiments, steps 402 and 404 may be performed as a single query of the storage device 212 for all outcomes of the identified treatments for the identified condition for all patients that (i) have or had the identified condition, (ii) have had one or more of the identified treatments on the identified conditions, and (iii) have one or more characteristics that are the same as or similar to the one or more characteristics of the patient identified by the patient information.

What is claimed is:

1. A method of recommending treatments, the method comprising:
receiving, at a computer, an identification of a condition from a device remote from the computer;
receiving an identification of treatments for the identified condition from a storage device;
receiving treatment information about the identified treatments from the storage device, wherein the received treatment information includes one or more of an indication of the clinical effectiveness of the identified treatments, data characterizing experiences of patients with the identified treatments, cost information, and insurance coverage;
generating initial rankings of the identified treatments based on the treatment information;
transmitting the initial rankings to the remote device;
receiving patient information identifying one or more characteristics of a patient from the remote device;
generating updated rankings of the identified treatments based on the treatment information and the received patient information; and
transmitting the updated rankings to the remote device.

2. The method of claim 1, wherein generating the updated rankings comprises:
receiving similar-patient information about the identified treatments from the storage device, wherein the similar-patient information includes treatment information specific to patients sharing one or more of the characteristics of the patient identified by the patient information; and
ranking the identified treatments based on the treatment information and the received similar-patient information.

3. The method of claim 2, wherein the similar-patient information includes one or more of an indication of the clinical effectiveness of the identified treatments for patients sharing one or more of the characteristics of the patient identified by the patient information and data characterizing the experiences of patients sharing one or more of the characteristics of the patient identified by the patient information with the identified treatments.

4. The method of claim 1, wherein the patient information includes clinical information.

5. The method of claim 4, wherein the clinical information includes condition status information.

6. The method of claim 5, wherein the condition status information includes an identification of one or more of the severity of the identified condition in the patient and the length of time that the patient has had the identified condition.

7. The method of claim 4, wherein the clinical information includes demographic information.

8. The method of claim 7, wherein the demographic information includes an identification of one or more of the gender of the patient, the race or ethnicity of the patient, the age of the patient, the height of the patient, the weight of the patient, the household income of the patient, the level of education achieved by the patient, the extent to which the patient's job is physically demanding, and whether the patient is a medical professional.

9. The method of claim 4, wherein the clinical information includes one or more of a previous condition of the patient, a current condition of the patient, and allergies of the patient.

10. The method of claim 1, wherein the patient information includes non-clinical information.

11. The method of claim 10, wherein the non-clinical information includes treatment preference information.

12. The method of claim 11, wherein the treatment preference information includes an identification of one or more treatments that the patient is currently using or leaning towards using for the identified condition.

13. The method of claim 10, wherein the non-clinical information includes treatment value information.

14. The method of claim 13, wherein the treatment value information includes an identification of the extent to which the patient values one or more of treatment effectiveness, how quickly a treatment works, treatment cost, treatment popularity of the treatment, and the side effects of a treatment when choosing a treatment.

15. The method of claim 10, wherein the non-clinical information includes willingness information.

16. The method of claim 15, wherein the willingness information includes an identification of one or more of the extent to which the patient is willing to take prescription medications, the extent to which the patient is willing to use alternative medicine therapies, and the extent to which the patient is willing to undergo surgery or other invasive treatments.

17. The method of claim 10, wherein the non-clinical information includes information about one or more behaviors of the patient.

18. The method of claim 1, further comprising:
receiving a selection of a treatment from the remote device;
transmitting detail information about the selected treatment to the remote device.

19. The method of claim 18, wherein the detail information comprises one or more of a description of the selected treatment, the popularity of the selected treatment with patients that have used the selected treatment, the effectiveness of the selected treatment with patients that have used the selected treatment, clinical evidence of effectiveness of the selected treatment, potential side effects of the selected treatment, potential impacts on work of the selected treatment, speed of effectiveness of the selected treatment, out-of-pocket costs of the selected treatment, total costs of the selected treatment, and potential pain of the selected treatment.

20. The method of claim 1, further comprising:
comparing the initial rankings and the updated rankings to generate difference information; and
transmitting the difference information to the remote device.

21. The method of claim 1, wherein:
generating the updated rankings comprises determining the impact of each of the one or more characteristics of the patient identified in the patient information on the updated rankings relative to the initial rankings; and
transmitting the updated rankings comprises transmitting the determined relative impact of each of the one or more characteristics of the patient.

22. The method of claim 1, wherein generating the updated rankings comprises ranking the identified treatments from the identified treatment most likely to be a good match for the patient to the identified treatment least likely to be a good match for the patient based on the received patient information.

23. The method of claim 1, wherein:
the storage device has a database stored therein, and the database contains information about patients, conditions that the patients had or have, treatments used on the conditions that the patients had or have, outcomes of the treatments used on the conditions that the patients have or had, and one or more of clinical information about the patients and non-clinical information about the patients; and
generating the updated rankings comprises:
determining one or more similar patients who have had one or more of the identified treatments on the identified condition;
receiving, from the storage device, similar patient outcome information for the one or more of the identified treatments used on the identified condition for the similar patients; and
ranking the identified treatments based on the treatment information and the received similar patient outcome information.

24. The method of claim 23, wherein the similar patient outcome information includes one or more outcomes of one or more treatments of the identified treatments on the identified condition of the similar patients, and the generating the updated rankings comprises, for each outcome, weighting the outcome based upon the degree to which the one or more characteristics of the patient identified by the received patient information matches one or more characteristics of the similar patient of the similar patients having the outcome.

25. The method of claim 23, wherein generating the updated rankings comprises using a predictive matching algorithm to analyze the received patient information against the information contained in the database and to generate predictions of the likelihood that the patient will consider the outcome of each of the identified treatments successful.

26. The method of claim 23, wherein generating the updated rankings comprises generating, for each of the similar patients, a confidence level that the similar patient is representative of the patient based upon the degree to which the one or more characteristics of the patient identified by the received patient information matches one or more characteristics of the similar patient.

27. The method of claim 1, further comprising:
creating a profile for the patient including the received patient information, and
transmitting the profile to the storage device.

28. The method of claim 1, further comprising:
receiving additional patient information identifying one or more additional characteristics of the patient;
generating further updated rankings of the identified treatments based on the treatment information, the received patient information, and the received additional patient information; and
transmitting the further updated rankings to the remote device.

29. The method of claim 1, further comprising receiving an identification of one of a profile or sub-profile for the patient from the remote device, wherein the identified one of the profile or sub-profile for the patient is stored in the storage device and includes stored patient information identifying one or more characteristics of the patient.

30. The method of claim 29, further comprising receiving the stored patient information from the storage device.

31. The method of claim 30, wherein generating the initial rankings is based on the treatment information and the stored patient information.

32. The method of claim 30, wherein generating the updated rankings is based on the treatment information, the received patient information, and the stored patient information.

33. A computer system for recommending treatments, the computer system comprising:
a storage device;
a computer; and
a computer readable medium storing computer readable instructions executable by said computer whereby said computer is operative to:
receive an identification of a condition from a remote device;
receive an identification of treatments for the identified condition from the storage device;
receive treatment information about the identified treatments from the storage device, wherein the received treatment information includes one or more of an indication of the clinical effectiveness of the identified treatments, data characterizing patients' experiences with the identified treatments, cost information, and insurance coverage;
generate initial rankings of the identified treatments based on the treatment information;
transmit the initial rankings to the remote device;
receive patient information identifying one or more characteristics of a patient from the remote device;
generate updated rankings of the identified treatments based on the treatment information and the received patient information; and
transmit the updated rankings to the remote device.

34. A computer program product for recommending treatments, the computer program product comprising a non-transitory computer readable medium storing computer readable instructions, the instructions comprising:
instructions for receiving an identification of a condition from a remote device;
instructions for receiving an identification of treatments for the identified condition from the storage device;
instructions for receiving treatment information about the identified treatments from the storage device, wherein the received treatment information includes one or more of an indication of the clinical effectiveness of the identified treatments, data characterizing patients' experiences with the identified treatments, cost information, and insurance coverage;
instructions for generating initial rankings of the identified treatments based on the treatment information;
instructions for transmitting the initial rankings to the remote device;
instructions for receiving patient information identifying one or more characteristics of a patient from the remote device;
instructions for generating updated rankings of the identified treatments based on the treatment information and the received patient information; and
instructions for transmitting the updated rankings to the remote device.
